(19) United States
(12) Patent Application Publication
(10) Pub. No.: US 2024/0355003 A1
(43) Pub. Date: Oct. 24, 2024

(54) ENCODING AND DECODING METHODS, AND BITSTREAM

(71) Applicant: GUANGDONG OPPO MOBILE TELECOMMUNICATIONS CORP., LTD., Dongguan (CN)

(72) Inventors: Hui YUAN, Dongguan (CN); Jinrui XING, Dongguan (CN); Lu WANG, Dongguan (CN); Tingting WANG, Dongguan (CN); Ming LI, Dongguan (CN)

(21) Appl. No.: 18/755,311

(22) Filed: Jun. 26, 2024

Related U.S. Application Data
(63) Continuation of application No. PCT/CN2021/143955, filed on Dec. 31, 2021.

(51) Int. Cl. G06T 9/00

(52) U.S. Cl. CPC G06T 9/001

(57) ABSTRACT

A decoding method includes the following. The bitstream is decoded to determine filtering identification information, where the filtering identification information is used to determine whether to filter a reconstructed point cloud. When the filtering identification information indicates to filter the reconstructed point cloud, the bitstream is decoded to determine filtering coefficients. K target points corresponding to a first point in the reconstructed point cloud are filtered with the filtering coefficients to determine a filtered point cloud corresponding to the reconstructed point cloud, where the K target points include the first point and (K−1) nearest points adjacent to the first point, K is an integer greater than 1, and the first point represents any point in the reconstructed point cloud.

### CROSS-REFERENCE TO RELATED APPLICATION(S)

This application is a continuation of International Application No. PCT/CN2021/143955, filed Dec. 31, 2021, the entire disclosure of which is incorporated herein by reference.

### TECHNICAL FIELD

Embodiments of the disclosure relate to the field of video encoding and decoding technology, and in particular to an encoding method, a decoding method, and a bitstream.

### BACKGROUND

At present, in an encoding and decoding framework of geometry-based point cloud compression (G-PCC), encoding of attribute information of a point cloud mainly aims at encoding of colour information. First, the colour information is converted from an RGB colour space to a YUV colour space. Then, the point cloud is recoloured with reconstructed geometric information, so that unencoded attribute information can correspond to the reconstructed geometric information. In encoding the colour information, three predicting transform manners, i.e., predicting transform, lifting transform, and region adaptive hierarchal transform (RAHT), are mainly used, and a binary bitstream is generated at last.

However, in the related art, in the existing G-PCC encoding and decoding framework, only basic reconstruction is performed on an initial point cloud. In the case of lossy attribute encoding, after reconstruction, a difference between a reconstructed point cloud and the initial point cloud may be relatively large, leading to severe distortion, thus affecting the quality of the entire point cloud.

### SUMMARY

In a first aspect, embodiments of the disclosure provide an encoding method applied to an encoder. The method includes the following. An initial point cloud and a reconstructed point cloud are determined. Filtering coefficients are determined according to the initial point cloud and the reconstructed point cloud. K target points corresponding to a first point in the reconstructed point cloud are filtered with the filtering coefficients to determine a filtered point cloud corresponding to the reconstructed point cloud, where the K target points include the first point and (K−1) nearest points adjacent to the first point, K is an integer greater than 1, and the first point represents any point in the reconstructed point cloud. Filtering identification information is determined according to the reconstructed point cloud and the filtered point cloud, where the filtering identification information is used to determine whether to filter the reconstructed point cloud. When the filtering identification information indicates to filter the reconstructed point cloud, the filtering identification information and the filtering coefficients are encoded, and obtained encoding bits are signalled into a bitstream.

In a second aspect, embodiments of the disclosure provide a decoding method applied to a decoder. The method includes the following. A bitstream is decoded to determine filtering identification information, where the filtering identification information is used to determine whether to filter a reconstructed point cloud. When the filtering identification information indicates to filter the reconstructed point cloud, the bitstream is decoded to determine filtering coefficients. K target points corresponding to a first point in the reconstructed point cloud are filtered with the filtering coefficients to determine a filtered point cloud corresponding to the reconstructed point cloud, where the K target points include the first point and (K−1) nearest points adjacent to the first point, K is an integer greater than 1, and the first point represents any point in the reconstructed point cloud.

In a third aspect, embodiments of the disclosure provide a no-transitory computer storage medium. The computer storage medium stores a bitstream generated according to the method in the first aspect.

### BRIEF DESCRIPTION OF THE DRAWINGS

FIG. 1 is a schematic diagram of a framework of a geometry-based point cloud compression (G-PCC) encoder.

FIG. 2 is a schematic diagram of a framework of a G-PCC decoder.

FIG. 3 is a schematic structural diagram illustrating zero run-length encoding.

FIG. 4 is a schematic flowchart 1 of an encoding method provided in embodiments of the disclosure.

FIG. 5 is a schematic flowchart 2 of an encoding method provided in embodiments of the disclosure.

FIG. 6 is a schematic diagram illustrating a relationship between a BD-Rate performance indicator and a K value in different components provided in embodiments of the disclosure.

FIG. 7 is a schematic diagram illustrating a relationship between coding time and a K value provided in embodiments of the disclosure.

FIG. 8 is a schematic flowchart 1 of a decoding method provided in embodiments of the disclosure.

FIG. 9 is a schematic flowchart 2 of a decoding method provided in embodiments of the disclosure.

FIG. 10 is a schematic diagram of an overall process of encoding and decoding provided in embodiments of the disclosure.

FIG. 11 is a schematic flowchart of filtering at an encoding end provided in embodiments of the disclosure.

FIG. 12 is a schematic flowchart of filtering at a decoding end provided in embodiments of the disclosure.

FIG. 13 is a schematic diagram illustrating a comparison of test results of predicting transform under the CY test condition provided in embodiments of the disclosure.

FIG. 14 is a schematic diagram illustrating a comparison of test results of lifting transform under the C1 test condition provided in embodiments of the disclosure.

FIG. 15 is a schematic diagram illustrating a comparison of test results of region adaptive hierarchal transform (RAHT) under the C1 test condition provided in embodiments of the disclosure.

FIG. 16 is a schematic diagram illustrating test results of lifting transform under the C2 test condition provided in embodiments of the disclosure.

FIG. 17 is a schematic diagram illustrating test results of RAHT under the C2 test condition provided in embodiments of the disclosure.

FIG. 18 is a schematic structural diagram of an encoder provided in embodiments of the disclosure.

FIG. 19 is a schematic diagram of a specific hardware structure of an encoder provided in embodiments of the disclosure.

FIG. 20 is a schematic structural diagram of a decoder provided in embodiments of the disclosure.

FIG. 21 is a schematic diagram of a specific hardware structure of a decoder provided in embodiments of the disclosure.

FIG. 22 is a schematic structural diagram of an encoding and decoding system provided in embodiments of the disclosure.

### DETAILED DESCRIPTION

To enable a more detailed understanding of features and technical content in embodiments of the disclosure, the embodiments of the disclosure are described in detail below in conjunction with the accompanying drawings which are provided for illustrative purposes only and are not intended to limit the disclosure.

Unless otherwise defined, all technical and scientific terms used herein have the same meaning as commonly understood by those skilled in the art. The terms used herein are for the purpose of describing embodiments of the disclosure only and are not intended to limit the disclosure.

In the following description, reference to “some implementations” describes a subset of all possible embodiments, but it is understood that “some implementations” may refer to the same or different subsets of all possible embodiments and may be combined with each other without conflict. It is noted that the terms “first/second/third” in embodiments of the disclosure are merely for distinguishing similar objects and do not imply a particular ordering with respect to the objects, and it is understood that “first/second/third” may, where appropriate, be interchanged in a particular order or sequence so that embodiments of the disclosure described herein may be implemented in an order other than that illustrated or described herein.

Before further detailed description of embodiments of the disclosure, the terms and terminology involved in embodiments of the disclosure are described, and the following explanation applies to the terms and terminology involved in embodiments of the disclosure.
geometry-based point cloud compression (G-PCC or GPCC)
video-based point cloud compression (V-PCC or VPCC)
Wiener filter
octree
bounding box
K nearest neighbour (KNN)
level of detail (LOD)
predicting transform
lifting transform
region adaptive hierarchal transform (RAHT)
peak signal to noise ratio (PSNR)
sum squared error (SSE)
minimum mean squared error (MMSE)
rate distortion optimization (RDO)
luminance component (L or Y)
chroma blue component (Cb)
chroma red component (Cr)

A point cloud is a three-dimensional (3D) representation of the surface of an object. The point cloud (data) of the surface of the object may be captured by means of a capturing equipment such as a photo radar, a LIDAR, a laser scanner, and a multi-view camera.

The point cloud is a collection of massive amounts of 3D points. A point in the point cloud may have both position information and attribute information of the point. For example, the position information of the point may be 3D coordinate information of the point. The position information of the point may also be referred to as geometric information of the point. For example, the attribute information of the point may include colour information and/or reflectance, etc. For example, the colour information may be information in any colour space. For example, the colour information may be RGB information, where R represents red, G represents green, and B represents blue. Another example of the colour information may be luminance-chrominance (YCbCr, YUV) information, where Y represents brightness (Luma), Cb (U) represents blue chrominance, and Cr (V) represents red chrominance.

For a point cloud obtained based on laser measurement, a point in the point cloud may include 3D coordinate information of the point and laser reflectance of the point. For a point cloud obtained based on photogrammetry, a point in the point cloud may include 3D coordinate information of the point and colour information of the point. For a point cloud obtained based on laser measurement and photogrammetry, a point in the point cloud may include the 3D coordinate information of the point, the laser reflectance of the point, and the colour information of the point.

Point clouds may be classified according to the obtaining manners as:
a first-type static point cloud: the object is stationary and the point cloud obtaining device is also stationary;
a second-type dynamic point cloud: the object is in motion, but the point cloud obtaining device is stationary; and
a third-type dynamically-obtained point cloud: the point cloud obtaining device is in motion.

For example, point clouds may be classified into two main categories according to usage:
category 1: machine perception point cloud, which may be used in scenarios such as autonomous navigation systems, real-time inspection systems, geographic information systems, visual sorting robots, and rescue and disaster relief robots; and
category 2: human eye perception point cloud, which may be used in scenarios such as digital cultural heritage, free point-of-view broadcasting, 3D immersive communication, and 3D immersive interaction.

As the point cloud is a collection of massive amounts of points, storing the point cloud not only consumes a lot of memory, but is also not conducive to transmission. Also, there is no such large bandwidth available to support the transmission of the point cloud directly across the network layer without compression. Therefore, the point cloud needs to be compressed.

As of today, point cloud coding frameworks that may compress the point cloud are either the G-PCC encoding and decoding framework or the V-PCC encoding and decoding framework provided by the moving picture experts group (MPEG), or the audio video standard (AVS)-PCC encoding and decoding framework provided by the AVS. The G-PCC encoding and decoding framework may be used for compression of the first-type static point cloud and the third-type dynamically-obtained point cloud, and the V-PCC encoding and decoding framework may be used for compression of the second-type dynamic point cloud. In embodiments of the disclosure, the description herein mainly focuses on the G-PCC encoding and decoding framework.

It can be understood that in the G-PCC encoding and decoding framework, a point cloud input into a 3D picture model is partitioned into slices, and then each of the slices is encoded independently.

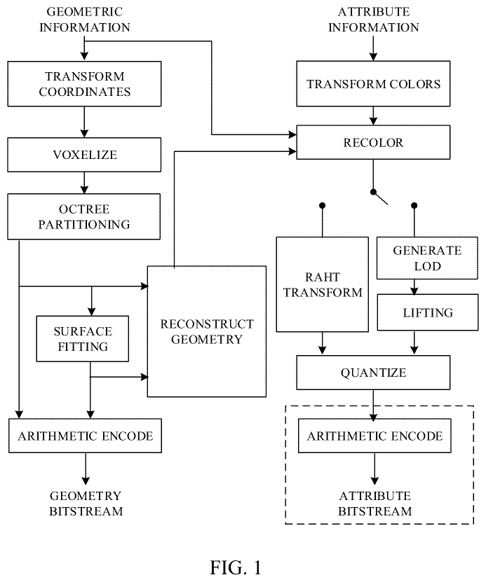

FIG. 1 is a schematic diagram of a framework of a G-PCC encoder. As illustrated in FIG. 1, the G-PCC encoder is applied to a point cloud encoder. In a G-PCC encoding framework, to-be-encoded point cloud data is firstly partitioned into slices. In each slice, the geometric information of the point cloud and attribute information corresponding to each point cloud are encoded separately. In a geometric encoding process, coordinate conversion is performed on the geometric information such that the whole point cloud is contained in a bounding box. This is followed by quantization, which is mainly a scaling process. Due to rounding in the quantization, some of the points have the same geometric information. Duplicate points are removed depending on parameters. The process of quantization and removing duplicate points is also known as voxelization. Next, octree partitioning is performed on the bounding box. In an octree-based geometric information encoding process, the bounding box is octeted into 8 sub-cubes. Non-empty sub-cubes (containing points in the point cloud) continue to be octeted until a resulting leaf node is a 1×1×1 unit cube. Arithmetic encoding is performed on points in the leaf node to generate a binary geometric bitstream, i.e., a geometric bitstream. In a triangle soup (trisoup)-based geometric information encoding process, the octree partitioning is also performed first. However, different from the octree-based geometric encoding, instead of partitioning the point cloud layer-by-layer into 1×1×1 unit cubes, the partitioning is stopped when the side length of the block is W. Based on a surface formed by distribution of the point cloud in each block, up to 12 vertexes generated between the 12 edges of the block and the surface are obtained. Arithmetic encoding is performed on the vertexes (with surface fitting performed based on the vertexes) to generate the binary geometric bitstream, i.e. the geometric bitstream. The vertexes are also used in the implementation of the geometric reconstruction, and reconstructed geometric information is used in attribute encoding of the point cloud.

In an attribute encoding process, after finishing geometric encoding and reconstructing the geometric information, colour conversion is performed to convert the colour information (i.e., attribute information) from the RGB colour space to the YUV colour space. The reconstructed geometric information is then used to recolour the point cloud, so as to make the uncoded attribute information correspond to the reconstructed geometric information. The attribute encoding is mainly focused on encoding of the colour information. There are two main transform methods for encoding of the colour information: 1. a distance-based lifting transform that relies on LOD partitioning; 2. a direct RAHT, both of which convert the colour information from the spatial domain to the frequency domain to obtain high frequency coefficients and low frequency coefficients. The coefficients are quantized (i.e., coefficient quantization). Finally, slice synthesis is performed on geometric encoded data obtained after octree partitioning and surface fitting and attribute encoded data obtained after coefficient quantization, and then the vertex coordinates of each block are encoded in sequence (i.e., arithmetic encoding) to generate a binary attribute bitstream, i.e., an attribute bitstream.

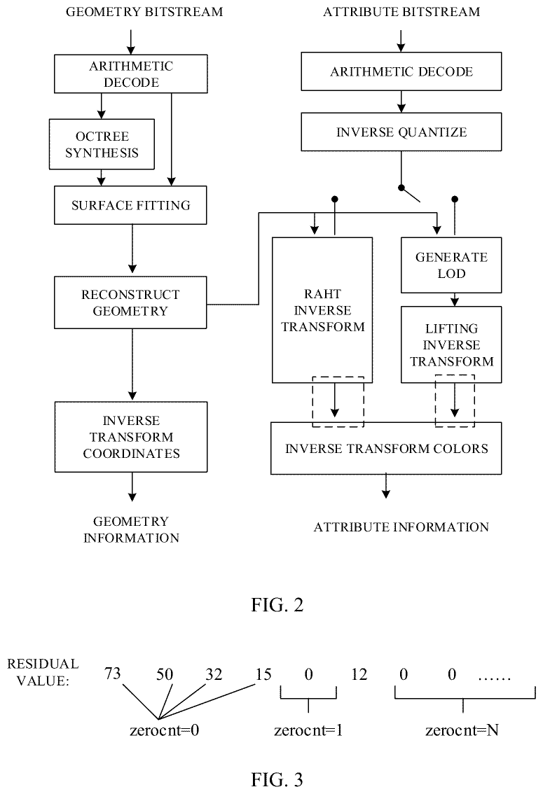

FIG. 2 is a schematic diagram of a framework of a G-PCC decoder. As illustrated in FIG. 2, the G-PCC decoder is applied to a point cloud decoder. In a G-PCC decoding framework, for an obtained binary bitstream, a geometric bitstream and an attribute bitstream in the binary bitstream are first decoded separately. In decoding of the geometric bitstream, geometric information of a point cloud is obtained through arithmetic decoding, octree synthesis, surface fitting, geometric reconstruction, and inverse coordinate conversion. In decoding of the attribute bitstream, attribute information of the point cloud is obtained through arithmetic decoding, inverse quantization, LOD-based lifting inverse transform or RAHT-based inverse transform, and inverse colour conversion. A 3D picture model of to-be-encoded point cloud data is restored based on the geometric information and the attribute information.

In the G-PCC encoder illustrated in FIG. 1 above, LOD partitioning is mainly used for two manners of point cloud attribute transform: predicting transform and lifting transform.

It is understood that LOD partitioning is performed after geometric reconstruction of the point cloud, and geometric coordinate information of the point cloud may be directly obtained. The point cloud is partitioned into multiple LODs according to an euclidean distance between points in the point cloud. Colours of points in the LODs are decoded in sequence. The number of zeros (represented by zero_cnt) in the zero run-length encoding technology is calculated, and a residual is decoded according to the value of zero_cnt.

Decoding is performed according to a zero run-length encoding method. First, the value of the first zero_cnt in the bitstream is decoded. If the first zero_cnt is greater than 0, it means that a zero_cnt number of consecutive residuals are 0. If zero_cnt is equal to 0, it means that an attribute residual of the point is not 0. Then a corresponding residual value is decoded, and the decoded residual value is inversely-quantized and added to a colour predicted value of a current point to obtain a reconstructed value of the point. This operation is continued until all points in the point cloud are decoded. For example, FIG. 3 is a schematic structural diagram illustrating zero run-length encoding. As illustrated in FIG. 3, if the residual value is 73, 50, 32, or 15, zero_cnt is equal to 0. If there is only one residual value and the residual value is 0, zero_cnt is equal to 1. If there are N residual values and the residual values are 0, zero_cnt is equal to N.

That is to say, a colour reconstructed value of the current point (represented by reconstructedColour) is calculated based on a colour predicted value (represented by predictedColour) under a current prediction mode and an inversely-quantized colour residual value (represented by residual) under the current prediction mode, that is, reconstructedColour=predictedColour+residual.

Furthermore, the current point will be used as the nearest neighbour of subsequent points in LOD, and the colour reconstructed value of the current point will be used for attribute prediction of the subsequent points.

However, in the existing G-PCC encoding and decoding framework, only basic reconstruction is performed on a point cloud sequence. After reconstruction, no certain operation is performed to further improve the quality of a colour attribute of the reconstructed point cloud. As such, the difference between the reconstructed point cloud and an original point cloud may be relatively large, leading to severe distortion, thus affecting the quality of the entire point cloud.

Based on this, embodiments of the disclosure provide an encoding method and a decoding method. The method may affect arithmetic encoding and subsequent parts in the G-PCC encoding framework, and may also affect the part after attribute reconstruction in the G-PCC decoding framework.

That is to say, embodiments of the disclosure provide an encoding method which may be applied to arithmetic encoding and subsequent parts illustrated in FIG. 1. Accordingly, embodiments of the disclosure further provide a decoding method which may be applied to the part after attribute reconstruction illustrated in FIG. 2.

In this way, at the encoding end, the initial point cloud and the reconstructed point cloud are used to calculate filtering coefficients for filtering, and the corresponding filtering coefficients are passed to a decoder after the reconstructed point cloud is determined to be filtered. Accordingly, at the decoding end, the filtering coefficients may be obtained directly by decoding and then used to filter the reconstructed point cloud, thereby optimizing the reconstructed point cloud and improving the quality of the point cloud. In addition, at the encoding end, for filtering using nearest points, the current point is also taken into account, so that a filtered value further depends on an attribute value of the current point. Moreover, not only a PSNR performance indicator but also a rate-distortion trade-off are considered for determining whether to filter the reconstructed point cloud. Furthermore, determination of correspondence between the reconstructed point cloud and the initial point cloud in a lossy geometry and lossy attribute case is also provided herein, so as to not only expand the scope of application and improve the quality of the point cloud, but also save bitrate and improve efficiency of encoding and decoding.

Embodiments of the disclosure will be clearly and completely described below with reference to the accompanying drawings.

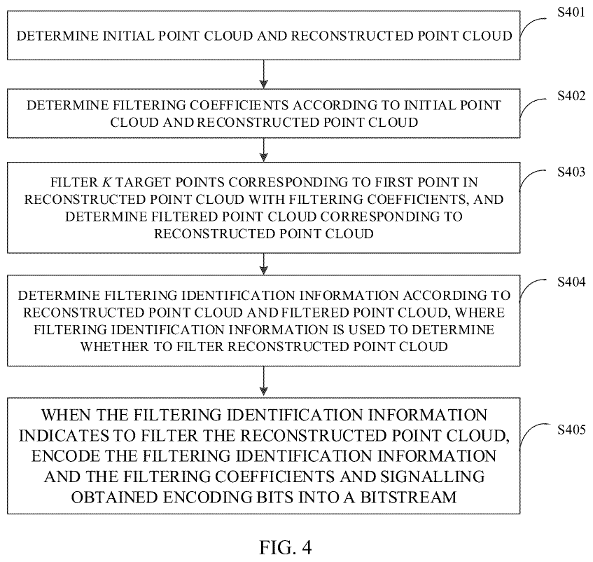

In an embodiment of the disclosure, reference is made to FIG. 4 which illustrates a schematic flowchart 1 of an encoding method provided in embodiments of the disclosure. As illustrated in FIG. 4, the method includes the following.

At S401, an initial point cloud and a reconstructed point cloud are determined.

It is noted that the encoding method described in the embodiment of the disclosure specifically refers to a point cloud encoding method, which may be applied to a point cloud encoder (referred to as “encoder” for short in the embodiment of the disclosure).

It is also noted that in the embodiment of the disclosure, the initial point cloud and the reconstructed point cloud may be determined first, and then the initial point cloud and the reconstructed point cloud are used to calculate filtering coefficients. In addition, during encoding of a point in the initial point cloud, the point may be used as a to-be-encoded point in the initial point cloud, and multiple encoded points exist around the point.

Further, in the embodiment of the disclosure, the point in the initial point cloud corresponds to geometric information and attribute information, where the geometric information represents a spatial position of the point, and the attribute information represents an attribute value (such as a colour component value) of the point.

In the embodiment, the attribute information may include a colour component and may specifically be colour information in any colour space. For example, the attribute information may be colour information in an RGB space, colour information in a YUV space, or colour information in a YCbCr space, etc., which is not limited in the embodiment of the disclosure.

Further, in the embodiment of the disclosure, the colour component may include a first colour component, a second colour component, and a third colour component. In this case, if the colour component complies with the RGB colour space, then the first colour component may be determined as an R component, the second colour component may be determined as a G component, and the third colour component may be determined as a B component. If the colour component complies with the YUV colour space, then the first colour component may be determined as a Y component, the second colour component may be determined as a U component, and the third colour component may be determined as a V component. If the colour component complies with the YCbCr colour space, then the first colour component may be determined as a Y component, the second colour component may be determined as a Cb component, and the third colour component may be determined as a Cr component.

It may be understood that, in the embodiment of the disclosure, the attribute information of the point in the initial point cloud may be a colour component, reflectance, or other attributes, which is not limited in the embodiment of the disclosure.

Further, in the embodiment of the disclosure, a predicted value and a residual value of the attribute information of the point in the initial point cloud may be determined first, and then a reconstructed value of the attribute information of the point is calculated with the predicted value and the residual value in order to construct the reconstructed point cloud. Specifically, during determination of the predicted value of the attribute information of the point in the initial point cloud, geometric information and attribute information of multiple target nearest points of the point may be used in combination with the geometric information of the point to predict the attribute information of the point, so as to obtain a corresponding predicted value and further determine a corresponding reconstructed value. In this way, after the reconstructed value of the attribute information of the point in the initial point cloud is determined, the point may be used as the nearest neighbour for subsequent points in LOD, so that the reconstructed value of the attribute information of the point may be used for attribute prediction of the subsequent points, and finally, a reconstructed point cloud is obtained.

That is to say, in the embodiment of the disclosure, the initial point cloud may be obtained directly through a point cloud reading function in an encoding and decoding program, and the reconstructed point cloud is obtained after attribute encoding, attribute reconstruction, and geometric compensation. In addition, the reconstructed point cloud in the embodiment of the disclosure may be used as a reconstructed point cloud output after decoding, or may be used as a reference for decoding subsequent point clouds. In addition, the reconstructed point cloud may be used in a prediction loop, that is, used in an in-loop filter, and may be used as the reference for decoding the subsequent point clouds. Alternatively, the reconstructed point cloud may be used outside the prediction loop, that is, used in a post filter, and is not used as the reference for decoding the subsequent point clouds, which is not limited in the embodiment of the disclosure.

It can also be understood that the embodiment of the disclosure is implemented in the case of lossy attribute encoding. Lossy attribute encoding includes: 1. lossless geometry and lossy attribute encoding, 2. lossy geometry and lossy attribute encoding. Therefore, in a possible implementation, at S401, the initial point cloud and the reconstructed point cloud may be determined as follows. When a first-type encoding manner is used to encode and reconstruct the initial point cloud, a first reconstructed point cloud is obtained, and the first reconstructed point cloud is determined as the reconstructed point cloud.

In another possible implementation, at S401, the initial point cloud and the reconstructed point cloud may be determined as follows.

When a second-type encoding manner is used to encode and reconstruct the initial point cloud, a second reconstructed point cloud is obtained. Geometric restoration is performed on the second reconstructed point cloud to obtain a restored reconstructed point cloud, and the restored reconstructed point cloud is determined as the reconstructed point cloud.

It is noted that in the embodiment of the disclosure, the first-type encoding manner is used to perform lossless geometry and lossy attribute encoding on the initial point cloud, and the second-type encoding manner is used to perform lossy geometry and lossy attribute encoding on the initial point cloud.

It is also noted that in a lossless geometry case, the number and coordinates of points in the reconstructed point cloud do not change. However, in a lossy geometry case, the number and coordinates of the points in the reconstructed point cloud and even a bounding box of the entire reconstructed point cloud will have big changes depending on different set bitrates, so that geometric restoration needs to be performed in this case.

Further, in some embodiments, geometric restoration is performed on the second reconstructed point cloud to obtain the restored reconstructed point cloud as follows.

Geometric compensation is performed on the second reconstructed point cloud to obtain an intermediate reconstructed point cloud. The intermediate reconstructed point cloud is scaled to obtain the restored reconstructed point cloud, where the restored reconstructed point cloud has a same size and a same geometric position as the initial point cloud.

That is to say, in the embodiment of the disclosure, geometric coordinates of the reconstructed point cloud are first pre-processed. After geometric compensation is performed, the geometric coordinate of each point is divided by a scale in a configuration parameter according to a reconstruction process. With the above operation, the reconstructed point cloud may be restored to a size equivalent to a bounding box of the initial point cloud and to the same geometric position as the initial point cloud (that is, offsets of the geometric coordinates are eliminated).

It is also noted that before the initial point cloud and reconstructed point cloud are input into a filter, correspondence between points in the reconstructed point cloud and points in the initial point cloud needs to be ensured. Therefore, in a possible implementation, the method may further include the following. When the first-type encoding manner is used, for a point in the reconstructed point cloud, a corresponding point in the initial point cloud is determined according to a first preset search manner, and correspondence between points in the reconstructed point cloud and points in the initial point cloud is established.

In another possible implementation, the method may further include the following. When the second-type encoding manner is used, for a point in the reconstructed point cloud, a corresponding point in the initial point cloud is determined according to a second preset search manner, and a matching point cloud is constructed according to the corresponding point determined. Taking the matching point cloud as the initial point cloud, correspondence between points in the reconstructed point cloud and points in the initial point cloud is established.

In a specific embodiment, for the point in the reconstructed point cloud, the corresponding point in the initial point cloud is determined according to the second preset search manner as follows. A second constant number of points is searched for in the initial point cloud based on a current point in the reconstructed point cloud by using the second preset search manner. Distances between the current point and each of the second constant number of points are calculated, and a minimum distance is selected from the distances. When the number of minimum distances is 1, a point corresponding to the minimum distance is determined as a corresponding point of the current point. When the number of minimum distances is multiple, a corresponding point of the current point is determined according to multiple points corresponding to the minimum distances.

It is noted that in the embodiment of the disclosure, the corresponding point of the current point is determined according to the multiple points corresponding to the minimum distances as follows. A point is randomly selected from the multiple points corresponding to the minimum distances, and the selected point is determined as the corresponding point of the current point. Alternatively, the multiple points corresponding to the minimum distances are merged, and the merged point is determined as the corresponding point of the current point, which is not limited herein.

It is also noted that in the embodiment of the disclosure, the first preset search manner is a K-nearest neighbour (KNN) search manner for searching for a first constant number of points, and the second preset search manner is a KNN search manner for searching for a second constant number of points. In a specific embodiment, the first constant is equal to 1, and the second constant is equal to 5, that is, the first preset search manner is a KNN search manner with k=1, and the second preset search manner is a KNN search manner with k=5, which is not limited herein.

That is to say, for the first-type encoding manner, that is, the lossless geometry and lossy attribute encoding manner, the number and coordinates of the points in the reconstructed point cloud obtained do not change, so that matching with corresponding points in the initial point cloud is relatively easy, and correspondence between points may be obtained by using only the KNN search manner with k=1. However, for the lossy geometry and lossy attribute encoding manner, the number and coordinates of the points in the reconstructed point cloud obtained and even the bounding box of the entire point cloud have big changes depending on different set bitrates. In this case, if more accurate correspondence between points is required, geometric coordinates of the reconstructed point cloud need to be pre-processed first. After geometric coordinate compensation is performed, the geometric coordinate of each point is divided by a scale in the configuration parameter according to the reconstruction process. With the above operation, the reconstructed point cloud may be restored to a size equivalent to the initial point cloud, and offsets of the geometric coordinate are eliminated, thus enabling the reconstructed point cloud to have the same geometric position as the initial point cloud. Subsequently, the KNN search manner with k=5 is used in the original point cloud for each point in the reconstructed point cloud. Distances between each of the 5 points and the current point are calculated in sequence, and the nearest point with the minimum distance is stored. If there are multiple nearest points with the same minimum distance, then a point may be randomly selected from the nearest points, or the nearest points may be merged into one point, that is, an average value of attribute values of the nearest points is taken as an attribute value of a matching nearest point of the current point. In this way, a point cloud that has the same number of points as the reconstructed point cloud can be obtained, where the points in the point cloud are in one-to-one correspondence with the points in the reconstructed point cloud. The point cloud is input as a real initial point cloud into the filter together with the reconstructed point cloud.

At S402, the filtering coefficients are determined according to the initial point cloud and the reconstructed point cloud.

It is noted that, in the embodiment of the disclosure, correspondence exists between points in the initial point cloud and points in the reconstructed point cloud. Before being inputted into the filter for filtering, K target points corresponding to the point in the reconstructed point cloud need to be determined first. Here, taking the current point as an example, K target points corresponding to the current point in the reconstructed point cloud may include the current point and (K−1) nearest points adjacent to the current point, where K is an integer greater than 1.

In some embodiments, the filtering coefficients are determined according to the initial point cloud and the reconstructed point cloud as follows. The filtering coefficients are determined according to a point in the initial point cloud and K target points corresponding to a point in the reconstructed point cloud.

In a specific embodiment, the K target points corresponding to the point in the reconstructed point cloud are determined as follows. A preset number of candidate points in the reconstructed point cloud are searched for based on a first point in the reconstructed point cloud by using a KNN search manner. A distances between the first point and each of the preset number of candidate points is calculated, and (K−1) distances are selected from the preset number of distances obtained, where the (K−1) distances are all smaller than remaining distances in the preset number of distances. (K−1) nearest points are determined according to candidate points corresponding to the (K−1) distances, and the first point and the (K−1) nearest points are determined as K target points corresponding to the first point.

It is noted that the first point may be any point in the reconstructed point cloud. Here, taking the first point as an example, the preset number of candidate points in the reconstructed point cloud may be searched for in the KNN search manner. Distances between the first point and each of the candidate points may be calculated, and then (K−1) nearest points closest to the first point may be selected from the candidate points. The first point and the (K−1) nearest points are determined as final K target points. That is to say, the K target points include not only the first point but also the (K−1) nearest points that have smallest geometric distances to the first point, which together form the K target points corresponding to the first point in the reconstructed point cloud.

It is also noted that the filter here may be an adaptive filter. For example, the filter may be a neural-network-based filter, a Wiener filter, etc., which is not limited herein.

In the embodiment of the disclosure, for example, the main function of the Wiener filter is to calculate the filtering coefficients and to determine whether the quality of the point cloud is improved after Wiener filtering. That is to say, the filtering coefficients described in the embodiment of the disclosure may be coefficients obtained through Wiener filtering, that is, the filtering coefficients are coefficients output by the Wiener filter.

Here, the Wiener filter is a linear filter with minimum mean square error as the optimal criterion. Under certain constraints, the square of the difference between an output of the Wiener filter and a given function (often called an expected output) is minimized, which may ultimately become a problem of solving a Toeplitz equation through mathematical operations. The Wiener filter is also called a least squares filter or a least mean squares filter.

Wiener filtering is currently one of the basic filtering methods, which uses correlation characteristics and spectral characteristics of a stationary random process to filter a noisy signal. The specific algorithm of Wiener filtering is as follows.

For a column of (noisy) input signals, when the length or order of the filter is M, the output of the filter is as follows.

$$y ( n ) = {\sum }_{m = 0}^{M} h ( m ) x ( n - m ) \qquad ( 1 )$$

M is the length or order of the filter, y(n) is an output signal, and x(n) is a column of (noisy) input signals.

The equation (1) is converted into a matrix form represented as follows.

$$y ( n ) = H ( m ) \times X ( n ) \qquad ( 2 )$$

Given an expected signal d(n), the error between the known signal and the expected signal may be calculated and represented as e(n) as follows.

$$e ( n ) = d ( n ) - y ( n ) = d ( n ) - H ( m ) \times X ( n ) , m = 0 , 1 , … M \qquad ( 3 )$$

The Wiener filter takes the minimum mean square error as a target function, so the target function is represented as follows.

$$Min E ( {e ( n )}^{2} ) = E [ {( d ( n ) - H ( m ) \times X ( n ) )}^{2} ] \qquad ( 4 )$$

When the filtering coefficient is optimal, the derivative of the target function with respect to the coefficient should be 0, that is:

$$\frac{d ( E ( {e ( n )}^{2} ) )}{dH} = 0 \qquad ( 5 )$$

that is:

$$2 E [ ( d ( n ) - H ( m ) \times X ( n ) ) ] \times X ( n ) = 0 \qquad ( 6 )$$

$$E [ d ( n ) X ( n ) ] - H ( m ) E [ X ( n ) X ( n ) ] = 0 \qquad ( 7 )$$

which further can be represented as:

$$Rxd - H \times Rxx = 0 \qquad ( 8 )$$

Rxd is a correlation matrix between the input signal and the expected signal, and Rxx is an auto-correlation matrix of the input signal. Therefore, by calculating the optimal solution according to the Wiener-Hopf equation, filtering coefficients H can be obtained as follows.

$$H = {Rxx}^{- 1} \times Rxd \qquad ( 9 )$$

Furthermore, for performing Wiener filtering, the noisy signal and the expected signal are required. In the embodiment of the disclosure, in the point cloud encoding and decoding framework, the reconstructed point cloud corresponds to the noisy signal, and the initial point cloud corresponds to the expected signal, so that the input of the Wiener filter can be determined. In this way, for S402, the filtering coefficients are determined according to the initial point cloud and the reconstructed point cloud as follows. The initial point cloud and the reconstructed point cloud are input into the Wiener filter to calculate and output the filtering coefficients.

In the embodiment of the disclosure, the initial point cloud and the reconstructed point cloud are input into the Wiener filter to calculate and output the filtering coefficients as follows. A first attribute parameter is determined according to an original value of attribute information of a point in the initial point cloud. A second attribute parameter is determined according to reconstructed values of attribute information of K target points corresponding to a point in the reconstructed point cloud. The filtering coefficients are determined based on the first attribute parameter and the second attribute parameter.

In a specific embodiment, the filtering coefficients are determined based on the first attribute parameter and the second attribute parameter as follows. A cross-correlation parameter is determined according to the first attribute parameter and the second attribute parameter. An auto-correlation parameter is determined according to the second attribute parameter. Coefficient calculation is performed according to the cross-correlation parameter and the auto-correlation parameter to obtain the filtering coefficients.

It is noted that, for the initial point cloud and the reconstructed point cloud, taking a colour component of attribute information as an example, if the colour component complies with the YUV space, then during determining the filtering coefficients according to the initial point cloud and the reconstructed point cloud, a first attribute parameter and a second attribute parameter of the colour component may be determined first based on an original value and a reconstructed value of the colour component (such as a Y component, a U component, or a V component), and then the filtering coefficients for filtering may be determined based on the first attribute parameter and the second attribute parameter.

Specifically, the first attribute parameter is determined according to an original value of attribute information of at least one point in the initial point cloud. The second attribute parameter is determined according to reconstructed values of attribute information of K target points corresponding to at least one point in the reconstructed point cloud. The K target points here include the current point and the (K−1) nearest points adjacent to the current point.

It is also noted that when the Wiener filter is used to determine the filtering coefficients, the order of the Wiener filter is also involved. In the embodiment of the disclosure, the order of the Wiener filter may be set equal to M. The value of M may be the same as or different from the value of K, which is not limited herein.

It is also noted that for the Wiener filter, a filter type can indicate a filter order and/or a filter shape and/or a filter dimension. The filter shape includes a diamond, a rectangle, etc. The filter dimension may be one dimension, two dimensions, or higher dimensions.

In this way, in the embodiment of the disclosure, different filter types may correspond to Wiener filters with different orders, for example, Wiener filters with orders of 12, 32, or 128. Different filter types may also correspond to filters with different dimensions, such as a one-dimensional filter, a two-dimensional filter, etc., which are not limited herein. In other words, if a 16-order filter needs to be determined, 16 points may be used to determine a 16-order asymmetric filter, an 8-order one-dimensional symmetric filter, or a filter with other numbers of dimensions (such as a two-dimensional filter, a three-dimensional filter, etc., which are more special). The filter is not limited herein.

To put it simply, in the embodiment of the disclosure, taking the colour component as an example, in the process of determining the filtering coefficients according to the initial point cloud and the reconstructed point cloud, the first attribute parameter of the colour component may be first determined according to an original value of a colour component of a point in the initial point cloud. Moreover, the second attribute parameter of the colour component may be determined according to reconstructed values of colour components of K target points corresponding to a point in the reconstructed point cloud. At last, a filtering coefficient vector corresponding to the colour component may be determined based on the first attribute parameter and the second attribute parameter. In this way, for one colour component, the first attribute parameter and the second attribute parameter corresponding to the colour component are calculated, and the filtering coefficient vector corresponding to the colour component is determined with the first attribute parameter and the second attribute parameter. After all colour components (such as the Y component, the U component, and the V component) are traversed, the filtering coefficient vector for each colour component may be obtained, so that the filtering coefficients may be determined based on the filtering coefficient vector for each colour component.

Specifically, during determining the filtering coefficients according to the initial point cloud and the reconstructed point cloud, a cross-correlation parameter corresponding to the colour component may be first determined according to the first attribute parameter and the second attribute parameter corresponding to the colour component. In addition, an auto-correlation parameter corresponding to the colour component may be determined according to the second attribute parameter. Then the filtering coefficient vector corresponding to the colour component may be determined based on the cross-correlation parameter and the auto-correlation parameter. At last, all colour components may be traversed, and the filtering coefficients can be determined with the filtering coefficient vectors corresponding to all the colour components.

For example, in the embodiment of the disclosure, taking a colour component in the YUV space in a point cloud sequence as an example, the order of the filter is assumed as K, that is, K target points corresponding to a point in the reconstructed point cloud are used to calculate an optimal coefficient, that is, to calculate a filtering coefficient. Here, the K target points may include the point and (K−1) nearest points adjacent to the point.

Assuming that the point cloud sequence is n, a vector S (n) is used to represent original values of a certain colour component (such as the Y component) of all points in the initial point cloud, that is, S (n) is a first attribute parameter including original values of the Y component of all points in the initial point cloud. A matrix P (n, k) is used to represent reconstructed values of the same colour component (such as the Y component) of K target points corresponding to each of all points in the reconstructed point cloud, that is, P (n, k) is a second attribute parameter including reconstructed values of the Y component of the K target points corresponding to each of all points in the reconstructed point cloud.

Specifically, the following Wiener filtering algorithm may be executed.

According to the first attribute parameter S(n) and the second attribute parameter P(n, k), a cross-correlation parameter B(k) is calculated and obtained as follows.

$$B ( k ) = {P ( n , k )}^{T} \times S ( n ) \qquad ( 10 )$$

According to the second attribute parameter P(n, k), an auto-correlation parameter A(k, k) is calculated and obtained as follows.

$$A ( k , k ) = {P ( n , k )}^{T} \times P ( n , k ) \qquad ( 11 )$$

According to the Wiener-Hopf equation, an optimal coefficient H(k) in the Y component, i.e., a filtering coefficient vector H(k) of a K-order Wiener filter in the Y component is as follows.

$$H ( k ) = {A ( k , k )}^{- 1} \times B ( k ) \qquad ( 12 )$$

Then, the U component and the V component may be traversed according to the above method. A filtering coefficient vector in the U component and a filtering coefficient vector in the V component are finally determined. The filtering coefficients can be determined with filtering coefficient vectors in all colour components.

Furthermore, the process of determining the filtering coefficients herein is based on the YUV colour space. If the initial point cloud or the reconstructed point cloud does not comply with the YUV colour space (for example, an RGB colour space), colour space conversion needs to be performed so that the point cloud complies with the YUV colour space. Therefore, in some embodiments, the method may further include the following. If a colour component of a point in the initial point cloud complies with the RGB colour space, colour space conversion is performed on the initial point cloud so that the colour component of the point in the initial point cloud complies with the YUV colour space. If a colour component of a point in the reconstructed point cloud complies with the RGB colour space, colour space conversion is performed on the reconstructed point cloud so that the colour component of the point in the reconstructed point cloud complies with the YUV colour space.

That is to say, during determining the filtering coefficients using the initial point cloud and the reconstructed point cloud, the first attribute parameter corresponding to each colour component can be determined based on colour components of points in the initial point cloud, and the second attribute parameter corresponding to each colour component can be determined based on colour components of points in the reconstructed point cloud. Then the filtering coefficient vector corresponding to each colour component can be determined. At last, the filtering coefficients can be obtained with the filtering coefficient vectors of all colour components.

At S403, K target points corresponding to a first point in the reconstructed point cloud are filtered with the filtering coefficients, and a filtered point cloud corresponding to the reconstructed point cloud is determined.

It is noted that the first point represents any point in the reconstructed point cloud. In addition, the K target points may include the first point and (K−1) nearest points adjacent to the first point, where K is an integer greater than 1. The (K−1) nearest points here specifically refer to (K−1) nearest points that have smallest geometric distances to the first point.

In the embodiment of the disclosure, after determining the filtering coefficients according to the initial point cloud and the reconstructed point cloud, the encoder may further determine the filtered point cloud corresponding to the reconstructed point cloud with the filtering coefficients. Specifically, in some embodiments, the K target points corresponding to the first point in the reconstructed point cloud need to be first determined, where the first point represents any point in the reconstructed point cloud. Then, the K target points corresponding to the first point in the reconstructed point cloud are filtered with the filtering coefficients to determine the filtered point cloud corresponding to the reconstructed point cloud as follows. The K target points corresponding to the first point in the reconstructed point cloud are filtered with the filtering coefficients to determine a filtered value of attribute information of the first point in the reconstructed point cloud. After a filtered value of attribute information of at least one point in the reconstructed point cloud is determined, the filtered point cloud is determined according to the filtered value of the attribute information of the at least one point.

In a specific embodiment, the K target points corresponding to the first point in the reconstructed point cloud are determined as follows. A preset number of candidate points in the reconstructed point cloud are searched for based on the first point in the reconstructed point cloud by using the KNN neighbour search manner. A distances between the first point and each of the preset number of candidate points is calculated, and (K−1) distances are selected from the preset number of distances obtained, where the (K−1) distances are all smaller than remaining distances in the preset number of distances. (K−1) nearest points are determined according to candidate points corresponding to the (K−1) distances, and the first point and the (K−1) nearest points are determined as the K target points corresponding to the first point.

It should be noted that taking the first point as an example, the preset number of candidate points in the reconstructed point cloud can be searched for in the KNN search manner. The distances between the first point and each of the candidate points can be calculated, and then (K−1) nearest points closest to the first point can be selected from the candidate points. That is to say, not only the first point but also the (K−1) nearest points that have smallest geometric distance to the first point together form the K target points corresponding to the first point in the reconstructed point cloud.

It is also noted that, still taking the colour component in the attribute information as an example, the K target points corresponding to the first point in the reconstructed point cloud are filtered with the filtering coefficients as follows. The K target points corresponding to the first point in the reconstructed point cloud are filtered with the filtering coefficient vector corresponding to the colour component to obtain a filtered value of a colour component of the first point in the reconstructed point cloud. The filtered point cloud is obtained according to the filtered value of the colour component of the point in the reconstructed point cloud.

Specifically, the filtered value of the colour component of each point in the reconstructed point cloud may be determined according to the filtering coefficient vector and the second attribute parameter corresponding to the colour component. The filtered point cloud may be obtained based on the filtered value of the colour component of each point in the reconstructed point cloud.

It can be understood that in the embodiment of the disclosure, during filtering the reconstructed point cloud using the Wiener filter, a noisy signal and an expected signal are required. In the point cloud encoding and decoding framework, the reconstructed point cloud may be used as the noisy signal, and the initial point cloud may be used as the expected signal. Therefore, the initial point cloud and the reconstructed point cloud may be both input into the Wiener filter, that is, the input of the Wiener filter is the initial point cloud and the reconstructed point cloud. The output of the Wiener filter is the filtering coefficients. After the filtering coefficients are obtained, the reconstructed point cloud may further be filtered based on the filtering coefficients to obtain the corresponding filtered point cloud.

That is to say, in the embodiment of the disclosure, the filtering coefficients are obtained based on the original point cloud and the reconstructed point cloud. Therefore, the original point cloud can be restored to the maximum extent by applying the filtering coefficients to the reconstructed point cloud. In other words, during determining the reconstructed point cloud according to the filtering coefficients, for one of the colour components, filtered values corresponding to the colour component may be determined based on a filtering coefficient vector corresponding to the colour component in combination with a second attribute parameter in the colour component.

For example, in the embodiment of the disclosure, by applying the filtering coefficient vector H (k) in the Y component to the reconstructed point cloud, i.e., the second attribute parameter P (n, k), filtered values R (n) of the Y component can be obtained as follows.

$$R ( n ) = P ( n , k ) \times H ( k ) \qquad ( 13 )$$

Then the U component and the V component can be traversed according to the method above. Filtered values of the U component and filtered values of the V component can be determined at last. Then the filtered point cloud corresponding to the reconstructed point cloud can be determined with filtered values in all colour components.

At S404, filtering identification information is determined according to the reconstructed point cloud and the filtered point cloud, where the filtering identification information is used to determine whether to filter the reconstructed point cloud.

In the embodiment of the disclosure, after obtaining the filtered point cloud corresponding to the reconstructed point cloud with the filtering coefficients, the encoder may further determine filtering identification information corresponding to the initial point cloud according to the reconstructed point cloud and the filtered point cloud.

It is noted that, in the embodiment of the disclosure, the filtering identification information may be used to determine whether to filter the reconstructed point cloud. Furthermore, the filtering identification information may further be used to determine which colour component(s) in the reconstructed point cloud should be filtered.

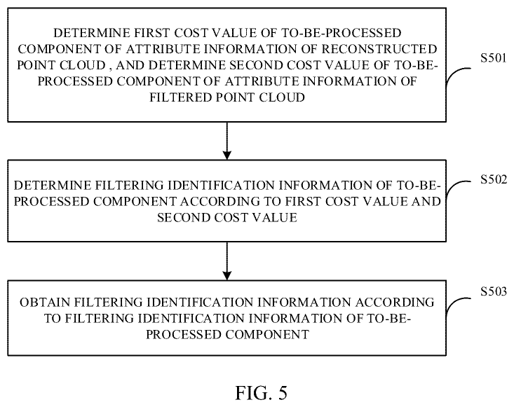

It is also noted that in the embodiment of the disclosure, the colour component may include at least one of: the first colour component, the second colour component, or the third colour component, where a to-be-processed component of the attribute information may be any one of the first colour component, the second colour component, or the third colour component. Reference is made to FIG. 5 which is a schematic flowchart 2 of an encoding method provided in embodiments of the disclosure. As illustrated in FIG. 5, for determination of the filtering identification information, the method can include the following.

At S501, a first cost value of a to-be-processed component of attribute information of a reconstructed point cloud is determined, and a second cost value of a to-be-processed component of attribute information of a filtered point cloud is determined.

It can be understood that, in a possible implementation, the first cost value of the to-be-processed component of the attribute information of the reconstructed point cloud is determined as follows. Cost-value calculation is performed on the to-be-processed component of the attribute information of the reconstructed point cloud by using a rate-distortion cost manner, and an obtained first rate-distortion value is determined as the first cost value. The second cost value of the to-be-processed component of the attribute information of the filtered point cloud is determined as follows. Cost-value calculation is performed on the to-be-processed component of the attribute information of the filtered point cloud by using the rate-distortion cost manner, and an obtained second rate-distortion value is determined as the second cost value.

In the implementation, the filtering identification information may be determined in the rate-distortion cost manner. First, the first cost value corresponding to the to-be-processed component of the attribute information of the reconstructed point cloud is determined in the rate-distortion cost manner, and the second cost value corresponding to the to-be-processed component the attribute information of the filtered point cloud is determined in the rate-distortion cost manner. Then filtering identification information of the to-be-processed component is determined according to a comparison result between the first cost value and the second cost value. The cost value here may be a distortion value used for distortion measurement, or may be a rate-distortion cost result, etc., which is not limited in the embodiment of the disclosure.

It is noted that in order to more accurately measure whether the performance is improved after filtering, in the embodiment of the disclosure, rate-distortion trade-off is considered on both the filtered point cloud and the reconstructed point cloud. A rate-distortion value considering both quality improvement and increased bitstream may be calculated in the rate-distortion cost manner. The first rate-distortion value and the second rate-distortion value can represent a rate-distortion cost result for the reconstructed point cloud and a rate-distortion cost result for the filtered point cloud respectively under the same colour component. The first rate-distortion value is used to represent compression efficiency of a point cloud that is not subject to filtering, and the second rate-distortion value is used to represent compression efficiency of the point cloud that is subject to filtering. Specifically, the first rate-distortion value and the second rate-distortion value may be calculated as follows.

$$J = D + λ \times {R}_{i} \qquad ( 14 )$$

Here, J is the rate-distortion value, D) is an SSE between the initial point cloud and the reconstructed point cloud or an SSE between the initial point cloud and the filtered point cloud, that is, the sum of squares of errors of corresponding points. λ is a value related to quantization parameter QP, and in the embodiment of the disclosure,

$$λ = 0.85 \times {2}^{\frac{QP - 12}{3}} . {R}_{i}$$

is the bitstream size of a colour component and is represented by bits. In the embodiment of the disclosure, the bitstream size of each colour component may be approximately given as Rᵢ=Rₐₗₗ/3+R_{coef}, where Rₐₗₗ is the size of an entire point cloud attribute bitstream, and R_{coef} is the bitstream size occupied by coefficients for each colour component (R_{coef}=K×sizeof(int) may be used for a filtered point cloud, and the component is not applied for the reconstructed point cloud).

In this way, after the reconstructed point cloud and the filtered point cloud are obtained, a first rate-distortion value of a to-be-processed component of the reconstructed point cloud and a second rate-distortion value of a to-be-processed component of the filtered point cloud may be calculated according to the above method. Taking the first rate-distortion value as the first cost value and taking the second rate-distortion value as the second cost value, the filtering identification information of the to-be-processed component is determined according to the comparison result between the first cost value and the second cost value.

It can also be understood that in another possible implementation, the first cost value of the to-be-processed component of the attribute information of the reconstructed point cloud is determined as follows. Cost-value calculation is performed on the to-be-processed component of the attribute information of the reconstructed point cloud by using the rate-distortion cost manner to obtain the first rate-distortion value. Performance-value calculation is performed on the to-be-processed component of the attribute information of the reconstructed point cloud according to a preset performance measurement indicator to obtain a first performance value. The first cost value is determined according to the first rate-distortion value and the first performance value. The second cost value of the to-be-processed component of the attribute information of the filtered point cloud is determined as follows. Cost-value calculation is performed on the to-be-processed component of the attribute information of the filtered point cloud by using the rate-distortion cost manner to obtain a second rate-distortion value. Performance-value calculation is performed on the to-be-processed component of the attribute information of the filtered point cloud according to a preset performance measurement indicator to obtain a second performance value. The second cost value is determined according to the second rate-distortion value and the second performance value.

In this implementation, not only the rate-distortion value determined in the rate-distortion cost manner but also the performance value (such as a PSNR value) determined with the preset performance measurement indicator may be considered. Here, the first performance value and the second performance value may represent the coding performance of the reconstructed point cloud and the coding performance of the filtered point cloud respectively in the same colour component. For example, in the embodiment of the disclosure, the first performance value may be a PSNR value of the colour component of the point in the reconstructed point cloud, and the second performance value may be a PSNR value of the colour component of the point in the filtered point cloud.

It is noted that considering that the ultimate purpose of the G-PCC encoding and decoding framework is point cloud compression, the higher the compression rate, the better the overall performance. In the embodiment of the disclosure, not only it can be determined whether to perform filtering at the decoding end based on the PSNR value, but also the rate-distortion cost manner can be used to consider rate-distortion trade-off before and after filtering. That is to say, after the reconstructed point cloud and the filtered point cloud are obtained, according to the above method, the first performance value and the first rate-distortion value of the to-be-processed component of the reconstructed point cloud may be calculated to obtain the first cost value, and the second performance value and the second rate-distortion value of the to-be-processed component of the filtered point cloud may be calculated to obtain the second cost value. Then the filtering identification information of the to-be-processed component is determined based on the comparison result between the first cost value and the second cost value.

In this way, not only improvement of the quality of an attribute value is considered, but also the cost of signalling information such as filtering coefficients into the bitstream is calculated. The improvement and the cost are considered together to determine whether the compression performance is improved after filtering, thereby determining whether to pass the filtering coefficients at the encoding end.

At S502, the filtering identification information of the to-be-processed component is determined according to the first cost value and the second cost value.

In a possible implementation, the filtering identification information of the to-be-processed component is determined according to the first cost value and the second cost value as follows.

When the second cost value is smaller than the first cost value, a value of the filtering identification information of the to-be-processed component is determined as a first value. When the second cost value is greater than the first cost value, the value of the filtering identification information of the to-be-processed component is determined as a second value.

It is noted that, for the case where the second cost value is equal to the first cost value, the value of the filtering identification information of the to-be-processed component may be determined as the first value, or the value of the filtering identification information of the to-be-processed component may be determined as the second value.

It is also noted that if the value of the filtering identification information of the to-be-processed component is the first value, then it may be determined that the filtering identification information of the to-be-processed component indicates to filter the to-be-processed component of the attribute information of the reconstructed point cloud. Alternatively, if the value of the filtering identification information of the to-be-processed component is the second value, it may be determined that the filtering identification information of the to-be-processed component indicates not to filter the to-be-processed component of the attribute information of the reconstructed point cloud.

In another possible implementation, the filtering identification information of the to-be-processed component is determined according to the first cost value and the second cost value as follows. When the second performance value is greater than the first performance value and the second rate-distortion value is smaller than the first rate-distortion value, the value of the filtering identification information of the to-be-processed component is determined as the first value. When the second performance value is smaller than the first performance value, the value of the filtering identification information of the to-be-processed component is determined as the second value.

In yet another possible implementation, the filtering identification information of the to-be-processed component is determined according to the first cost value and the second cost value as follows. When the second performance value is greater than the first performance value and the second rate-distortion value is smaller than the first rate-distortion value, the value of the filtering identification information of the to-be-processed component is determined as the first value. When the second rate-distortion value is greater than the first rate-distortion value, the value of the filtering identification information of the to-be-processed component is determined as the second value.

It is noted that, when the second performance value is equal to the first performance value or when the second rate-distortion value is equal to the first rate-distortion value, the value of the filtering identification information of the to-be-processed component may be determined as the first value, or the value of the filtering identification information of the to-be-processed component may be determined as the second value.

It is also noted that when the value of the filtering identification information of the to-be-processed component is the first value, it may be determined that the filtering identification information of the to-be-processed component indicates to filter the to-be-processed component of the attribute information of the reconstructed point cloud. Alternatively, when the value of the filtering identification information of the to-be-processed component is the second value, it may be determined that the filtering identification information of the to-be-processed component indicates not to filter the to-be-processed component of the attribute information of the reconstructed point cloud.

It can also be understood that when the to-be-processed component is the colour component(s), for one or more of these colour components, it may be determined, according to the first performance value, the first rate-distortion value, the second performance value, and the second rate-distortion value, whether the performance value for the filtered point cloud is increased compared to the performance value for the reconstructed point cloud, and whether the rate-distortion cost for the filtered point cloud is decreased compared to the rate-distortion cost for the reconstructed point cloud.

In a possible implementation, when the to-be-processed component is a first colour component, for S502, the filtering identification information of the to-be-processed component is determined according to the first cost value and the second cost value as follows. When the second performance value is greater than the first performance value and the second rate-distortion value is smaller than the first rate-distortion value, the value of the filtering identification information of the first colour component is determined as the first value. When the second performance value is smaller than the first performance value or when the second rate-distortion value is greater than the first rate-distortion value, the value of the filtering identification information of the first colour component is determined as the second value.

In another possible implementation, when the to-be-processed component is a second colour component, for S502, the filtering identification information of the to-be-processed component is determined according to the first cost value and the second cost value as follows. When the second performance value is greater than the first performance value and the second rate-distortion value is smaller than the first rate-distortion value, a value of filtering identification information of the second colour component is determined as the first value. When the second performance value is smaller than the first performance value or when the second rate-distortion value is greater than the first rate-distortion value, the value of the filtering identification information of the second colour component is determined as the second value.

In yet another possible implementation, when the to-be-processed component is a third colour component, for S502, the filtering identification information of the to-be-processed component is determined according to the first cost value and the second cost value as follows. When the second performance value is greater than the first performance value and the second rate-distortion value is smaller than the first rate-distortion value, a value of filtering identification information of the third colour component is determined as the first value. When the second performance value is smaller than the first performance value or when the second rate-distortion value is greater than the first rate-distortion value, the value of the filtering identification information of the third colour component is determined as the second value.

Specifically, in the embodiment of the disclosure, taking a PSNR and a rate-distortion cost result (Cost) of the Y component as examples, during determining filtering identification information of the Y component according to the first performance value, the first rate-distortion value, the second performance value, and the second rate-distortion value, if PSNR1 corresponding to the reconstructed point cloud is greater than PSNR2 corresponding to the filtered point cloud, or if Cost1 corresponding to the reconstructed point cloud is smaller than Cost2 corresponding to the filtered point cloud, that is, a PSNR value of the Y component is decreased after filtering, or the rate-distortion cost of the Y component is increased after filtering, then it is considered that the filtering is not effective. In this case, the filtering identification information of the Y component will be set to indicate not to filter the Y component. Accordingly, if PSNR1 corresponding to the reconstructed point cloud is smaller than PSNR2 corresponding to the filtered point cloud, and Cost1 corresponding to the reconstructed point cloud is greater than Cost2 corresponding to the filtered point cloud, that is, PSNR of the Y component is increased after filtering, and the rate-distortion cost of the Y component is decreased after filtering, then it is considered that the filtering is effective. In this case, the filtering identification information of the Y component will be set to indicate to filter the Y component.

In this way, in the embodiments of the disclosure, the U component and the V component may be traversed according to the above method, and filtering identification information of the U component and filtering identification information of the V component may be determined at last, so as to determine the final filtering identification information by using filtering identification information of all colour components.

At S503, the filtering identification information is obtained according to the filtering identification information of the to-be-processed component.

It is noted that in the embodiment of the disclosure, the filtering identification information is determined by using the filtering identification information of the to-be-processed component as follows. When the to-be-processed component is the colour component, the filtering identification information of the first colour component, the filtering identification information of the second colour component, and the filtering identification information of the third colour component are determined. The filtering identification information is obtained according to the filtering identification information of the first colour component, the filtering identification information of the second colour component, and the filtering identification information of the third colour component.

That is to say, the filtering identification information may be in the form of an array, which is specifically a 1×3 array and includes the filtering identification information of the first colour component, the filtering identification information of the second colour component, and the filtering identification information of the third colour component. For example, the filtering identification information may be represented as [y u v], where y represents the filtering identification information of the first colour component, u represents the filtering identification information of the second colour component, and y represents the filtering identification information of the third colour component.

It can be seen that since the filtering identification information includes filtering identification information of each colour component, the filtering identification information can not only be used to determine whether to filter the reconstructed point cloud, but also be used to determine which colour component is to be filtered.

Further, in some embodiments, the method may further include the following. If the value of the filtering identification information of the first colour component is the first value, it is determined to filter the first colour component of the reconstructed point cloud, and if the value of the filtering identification information of the first colour component is the second value, it is determined not to filter the first colour component of the reconstructed point cloud. If the value of the filtering identification information of the second colour component is the first value, it is determined to filter the second colour component of the reconstructed point cloud, and if the value of the filtering identification information of the second colour component is the second value, it is determined not to filter the second colour component of the reconstructed point cloud. If the value of the filtering identification information of the third colour component is the first value, it is determined to filter the third colour component of the reconstructed point cloud, and if the value of the filtering identification information of the third colour component is the second value, it is determined not to filter the third colour component of the reconstructed point cloud.

That is to say, in the embodiment of the disclosure, if filtering identification information corresponding to a certain colour component is the first value, the filtering identification information indicates to filter the colour component. If filtering identification information corresponding to a certain colour component is the second value, the filtering identification information indicates not to filter the colour component.

Further, in some embodiments, the method may further include the following. When at least one of the filtering identification information of the first colour component, the filtering identification information of the second colour component, and the filtering identification information of the third colour component is a first value, it is determined that the filtering identification information indicates to filter the reconstructed point cloud. When each of the filtering identification information of the first colour component, the filtering identification information of the second colour component, and the filtering identification information of the third colour component is a second value, it is determined that the filtering identification information indicates not to filter the reconstructed point cloud.

That is to say, in the embodiment of the disclosure, if filtering identification information corresponding to each colour component is the second value, the filtering identification information indicates not to filter any of the colour components, that is, it can be determined that the filtering identification information indicates not to filter the reconstructed point cloud. Accordingly, if at least one of the filtering identification information of the colour components is the first value, the filtering identification information indicates to filter at least one colour component, that is, it can be determined that the filtering identification information indicates to filter the reconstructed point cloud.

In addition, in the embodiment of the disclosure, the first value is different from the second value, and the first value and the second value may be in parameter form or in numerical form. Specifically, the identification information corresponding to the colour components may be parameters written in a profile, or may be a value of a flag, which is not limited herein.

For example, for the first value and the second value, the first value may be set as 1, and the second value may be set as 0. Alternatively, the first value may be set as true, and the second value may be set as false, which is not limited herein.

At S405, when the filtering identification information indicates to filter the reconstructed point cloud, the filtering identification information and the filtering coefficients are encoded, and obtained encoding bits are signalled into a bitstream.

It is noted that in the embodiment of the disclosure, after the encoder determines the filtering identification information according to the reconstructed point cloud and the filtered point cloud, if the filtering identification information indicates to filter the reconstructed point cloud, the filtering identification information can be signalled into the bitstream, and the filtering coefficients can also be signalled into the bitstream if needed.

For example, the filtering identification information may be [1 0 1]. In this case, the value of the filtering identification information of the first colour component is 1, that is, the first colour component of the reconstructed point cloud needs to be filtered. The value of the filtering identification information of the second colour component is 0, that is, the second colour component of the reconstructed point cloud does not need to be filtered. The value of the filtering identification information of the third colour component is 1, that is, the third colour component of the reconstructed point cloud needs to be filtered. Therefore, only the filtering coefficient corresponding to the first colour component and the filtering coefficient corresponding to the third colour component need to be signalled into the bitstream, without signalling the filtering coefficient corresponding to the second colour component into the bitstream.

It is also noted that in the embodiment of the disclosure, for the second-type encoding manner, that is, the lossy geometry and lossy attribute encoding manner, if the geometric distortion is too large, it can be directly determined not to filter the reconstructed point cloud in this case. Therefore, in some embodiments, the method may further include the following. If the quantization parameter of the reconstructed point cloud is greater than a preset threshold value, it is determined that the filtering identification information indicates not to filter the reconstructed point cloud.

That is to say, in the lossy geometry case, when the geometric distortion is large (that is, the quantization parameter is greater than the preset threshold value), the number of points in the reconstructed point cloud is relatively small. If filtering coefficients of approximately the same size are signalled, the rate-distortion cost will be too large. Therefore, Wiener filtering is not performed in this case.

Further, in some embodiments, when the filtering identification information indicates not to filter the reconstructed point cloud, the method can further include the following. Only the filtering identification information is encoded, and the obtained encoding bits are signalled into the bitstream.

It is noted that, in the embodiment of the disclosure, after the encoder obtains, with the filtering coefficients, the filtered point cloud corresponding to the reconstructed point cloud, the encoder may further determine the filtering identification information according to the reconstructed point cloud and the filtered point cloud. If the filtering identification information indicates to filter the reconstructed point cloud, the filtering identification information and the filtering coefficients may be signalled into the bitstream. If the filtering identification information indicates not to filter the reconstructed point cloud, then the filtering coefficient does not need to be signalled into the bitstream, and only the filtering identification information needs to be signalled into the bitstream for subsequent transmission to a decoder through the bitstream.

It is also noted that in the embodiment of the disclosure, the method can further include the following. A predicted value of attribute information of a point in the initial point cloud is determined. A residual value of the attribute information of the point in the initial point cloud is determined according to an original value and the predicted value of attribute information of the colour component of the point in the initial point cloud. The residual value of the attribute information of the point in the initial point cloud is encoded, and obtained encoding bits are signalled into the bitstream. That is to say, after the encoder determines the residual value of the attribute information, the encoder further needs to signal the residual value of the attribute information into the bitstream for subsequent transmission to the decoder through the bitstream.

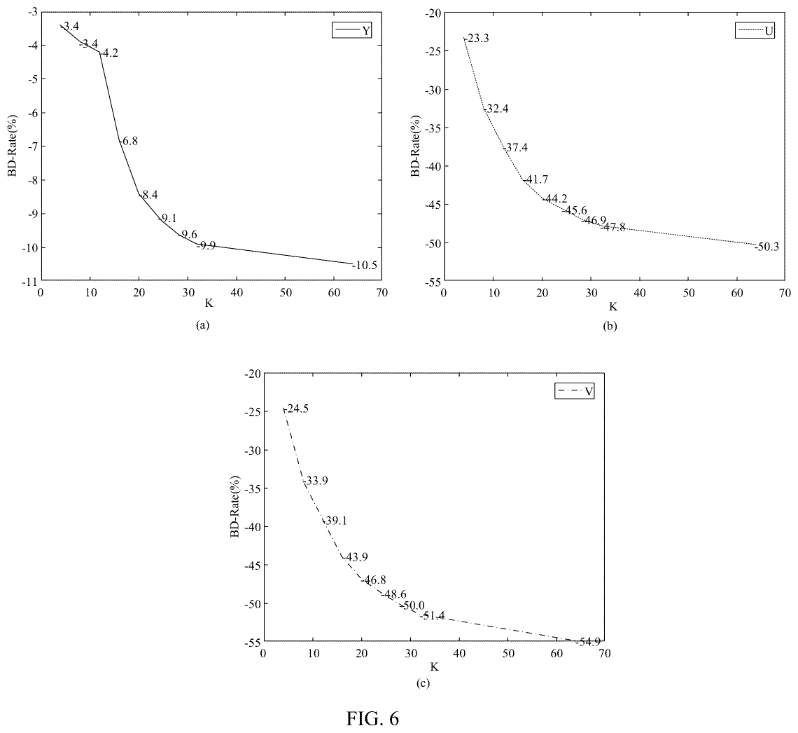

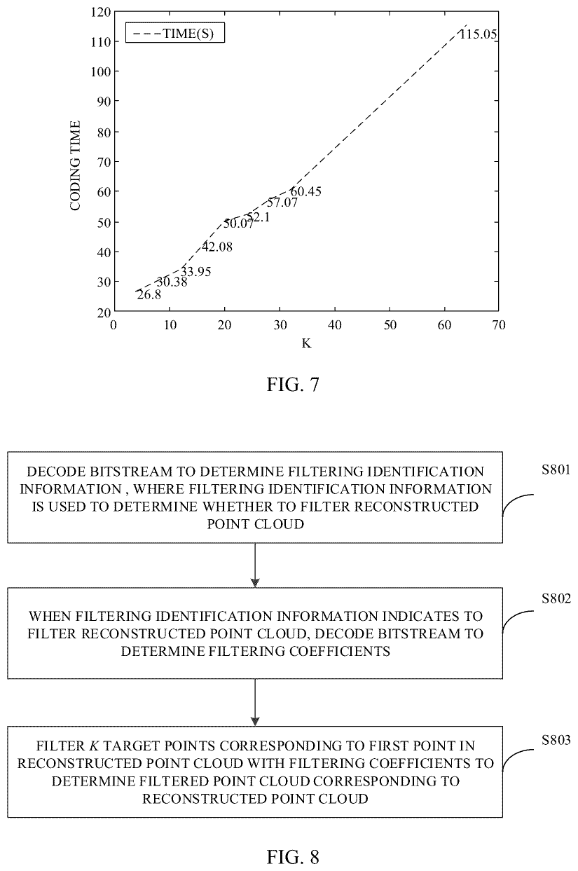

Furthermore, in the embodiment of the disclosure, assuming that the order of the Wiener filter is the same as the value of K. In this case, K may be set equal to 16 or another value. Specifically, based on a sequence loot_vox 12_1200.ply, the BD-Rate gains and running times for the to-be-filtered point cloud and the filtered point cloud using lifting transform are tested under the CTC_C1 (lossless geometry and lossy attribute) condition and r1-r6 bitrates. The test results are illustrated in FIG. 6 and FIG. 7. In FIG. 6, (a) illustrates the variation of the BD-Rate performance indicator corresponding to the Y component with the K value, (b) illustrates the variation of the BD-Rate performance indicator corresponding to the U component with the K value, and (c) illustrates the variation of the BD-Rate performance indicator corresponding to the V component with the K value. It can be seen that the BD-Rate performance indicator changes slowly when the K value is too large (such as greater than about 20). FIG. 7 illustrates the variation of the total coding time for all bitrates with the K value. It can be seen that the coding time basically has a linear relationship with the K value. According to FIG. 6 and FIG. 7, it can be seen that excessive increasing of the K value is not beneficial to performance improvement, and an excessively large K value is prone to memory overflow when processing a large point cloud and reduces universality. Therefore, in the embodiment of the disclosure, the K value can be set as 16, which can not only ensure the filtering effect, but also reduce time complexity to a certain extent.

In addition, in the embodiment of the disclosure, for determination of the K value, the method may further include the following. The value of K is determined according to a point number of the reconstructed point cloud, and/or the value of K is determined according to a quantization parameter of the reconstructed point cloud, and/or the value of K is determined according to a neighbourhood difference value of the point in the reconstructed point cloud.

In the embodiment of the disclosure, the neighbourhood difference value may be calculated based on a component difference between a to-be-filtered colour component of a point and a to-be-filtered colour component of at least one nearest point.

Further, the value of K is determined according to the neighbourhood difference value of the point in the reconstructed point cloud as follows. When the neighbourhood difference value of the point in the reconstructed point cloud is in a first preset interval, a first-type filter is selected to filter the reconstructed point cloud. When the neighbourhood difference value of the point in the reconstructed point cloud is in a second preset interval, a second-type filter is selected to filter the reconstructed point cloud, where an order of the first-type filter is different from an order of the second-type filter.

It is noted that in a possible implementation, different K are selected for filtering point clouds of different sizes. Specifically, a threshold may be set according to the number of points to achieve adaptive selection of K. When the number of points in the point cloud is small, K can be increased appropriately to improve quality. When the number of points in the point cloud is large, K can be decreased appropriately to first ensure that the memory is sufficient and the running speed is not too slow.

It is also noted that in another possible implementation, the neighbourhood difference value is considered for Wiener filtering. Due to the large changes in attribute values at the point cloud contour or boundary, a single filter may be not suitable for filtering the entire point cloud, thus leaving room for improvement in effect, especially for sparse point cloud sequences. Therefore, classification may be performed according to the neighbourhood difference value, and different filters may be applied to different categories, thereby passing multiple sets of filtering coefficients. In this way, an adaptive selection of filters can be achieved for better filtering effects.

It is also noted that in another possible implementation, in the lossy geometry encoding case, when the geometric distortion is large (i.e., the quantization parameter is large), Wiener filtering is no longer performed. Alternatively, K is adaptively adjusted according to the quantization parameter to reduce the overhead of the bitstream. Alternatively, entropy encoding may be performed on to-be-passed filtering coefficients or to-be-passed filtering identification information to eliminate information redundancy and further improve coding efficiency.

In short, the embodiment of the disclosure proposes an optimized technology for performing Wiener filtering on the YUV component of the coding colour reconstructed value to better improve the quality of the point cloud, specifically through the encoding method proposed in operations at S401 to S405. During filtering of the colour component (such as the Y component, the U component, and the V component) of the colour reconstructed value of the point cloud sequence, the Wiener filter-based post-processing method for point cloud in both the lossless geometry and lossy attribute case and the lossy geometry and lossy attribute case is considered. Further, the judgment for quality improvement, nearest point selection, and the value of K are optimized. In this way, the quality improvement operation for the reconstructed point cloud that is output by the decoding end can be selectively performed, the number of bits of the bitstream can have a relatively small increase, and the overall compression performance can be improved.

It is noted that the encoding method proposed in the embodiment of the disclosure is applicable for any point cloud sequence, and has a prominent optimization effect especially for a sequence with densely distributed points and a sequence with a medium bitrate. In addition, the encoding method proposed in the embodiment of the disclosure can be applied to all of three attribute transform (predicting transform, lifting transform, and RAHT) encoding manners, and has universality. For a very small number of sequences with poor filtering effects, the method will not affect the reconstruction process at the decoding end. Except for a slight increase in the running time at the encoding end, the impact of the filtering identification information on the size of the attribute bitstream is negligible.

It is noted that the Wiener filter proposed in the embodiment of the disclosure may be used in a prediction loop, that is, used as an in-loop filter, and may be used as a reference for decoding subsequent point clouds. Alternatively, the Wiener filter may be used outside the prediction loop, that is, used as a post filter, and is not used as a reference for decoding subsequent point clouds, which is not limited herein.

It is noted that in the embodiment of the disclosure, if the Wiener filter proposed in the embodiment of the disclosure is the in-loop filter, when it is determined to perform filtering, parameter information (such as the filtering identification information) indicating to perform filtering needs to be signalled into the bitstream, and the filtering coefficients also need to be signalled into the bitstream. Accordingly, when it is determined not to perform filtering, the parameter information (such as the filtering identification information) indicating to perform filtering may not be signalled into the bitstream, and the filtering coefficients may also not be signalled into the bitstream. On the contrary, if the Wiener filter proposed in the embodiment of the disclosure is the post filter, in one case, the filtering coefficients corresponding to the filter are in a separate auxiliary information data unit (for example, supplementary enhancement information, SEI). In this case, the parameter information (such as the filtering identification information) indicating to perform filtering may not be signalled into the bitstream, and the filtering coefficients may also not be signalled into the bitstream. Accordingly, when the decoder does not obtain the SEI, the reconstructed point cloud will not be filtered. In another case, the filtering coefficients corresponding to the filter are in an auxiliary information data unit together with other information. In this case, when it is determined to perform filtering, the parameter information (such as the filtering identification information) indicating to perform filtering needs to be signalled into the bitstream, and the filtering coefficients also need to be signalled into the bitstream. Accordingly, when it is determined not to perform filtering, the parameter information (such as filtering identification information) indicating to perform filtering may not be signalled into the bitstream, and the filtering coefficients may also not be signalled into the bitstream.

Furthermore, for the encoding method proposed in the embodiment of the disclosure, filtering may be selectively performed on one or more parts of the reconstructed point cloud, that is, the control range of the filtering identification information may be the entire reconstructed point cloud or may be a certain part of the reconstructed point cloud, which is not limited herein.

The embodiment provides the encoding method which is applied to the encoder. The initial point cloud and the reconstructed point cloud are determined. The filtering coefficients are determined according to the initial point cloud and the reconstructed point cloud. K target points corresponding to the first point in the reconstructed point cloud are filtered with the filtering coefficients, to determine the filtered point cloud corresponding to the reconstructed point cloud, where the K target points include the first point and (K−1) nearest points adjacent to the first point, K is an integer greater than 1, and the first point represents any point in the reconstructed point cloud. The filtering identification information is determined according to the reconstructed point cloud and the filtered point cloud, where the filtering identification information is used to determine whether to filter the reconstructed point cloud. When the filtering identification information indicates to filter the reconstructed point cloud, the filtering identification information and filtering coefficients are encoded, and the obtained encoding bits are signalled into the bitstream. In this way, at the encoding end, for filtering using nearest points, a current point is also taken into account, so that a filtered value further depends on an attribute value of the current point. Moreover, not only a PSNR performance indicator but also a rate-distortion trade-off are considered for determining whether to filter the reconstructed point cloud. Furthermore, determination of correspondence between the reconstructed point cloud and the initial point cloud in a lossy geometry and lossy attribute case is also provided herein, so as to not only expand the scope of application, optimize the reconstructed point cloud, and improve the quality of the point cloud, but also save bitrate and improve efficiency of encoding and decoding.

In another embodiment of the disclosure, the embodiment of the disclosure further provides a bitstream which is generated by bit encoding according to to-be-encoded information, where the to-be-encoded information includes at least one of: a residual value of attribute information of a point in an initial point cloud, filtering identification information, and filtering coefficients.

In this way, when the residual value, the filtering identification information, and the filtering coefficients of the attribute information of the point in the initial point cloud are passed from an encoder to a decoder, the decoder decodes to obtain the residual value of the attribute information of the point in the initial point cloud and constructs a reconstructed point cloud. The decoder further decodes to obtain the filtering identification information, and can determine whether to filter the reconstructed point cloud. When the reconstructed point cloud needs to be filtered, the filtering coefficients can be directly decoded. The reconstructed point cloud is filtered according to the filtering coefficients, thereby optimizing the reconstructed point cloud and improving the quality of the point cloud.

In yet another embodiment of the disclosure, reference is made to FIG. 8 which illustrates a schematic flowchart 1 of a decoding method provided in embodiments of the disclosure. As illustrated in FIG. 8, the method includes the following.

At S801, a bitstream is decoded to determine filtering identification information, where the filtering identification information is used to determine whether to filter a reconstructed point cloud.

It is noted that the decoding method described in the embodiment of the disclosure specifically refers to a point cloud decoding method which can be applied to a point cloud decoder (in the embodiment of the disclosure, the point cloud decoder may be referred to as a “decoder” for short).

It is also noted that in the embodiment of the disclosure, the decoder may first decode the bitstream to determine the filtering identification information, where the filtering identification information may be used to determine whether to filter the reconstructed point cloud. Specifically, the filtering identification information may further be used to determine which colour component(s) in the reconstructed point cloud should be filtered.

It is also noted that in the embodiment of the disclosure, for a point in the initial point cloud, during decoding of the point, the point may be used as a to-be-decoded point in the initial point cloud, and multiple decoded points exist around the point.

Further, in the embodiment of the disclosure, the point in the initial point cloud corresponds to geometric information and attribute information, where the geometric information represents a spatial position of the point, and the attribute information represents an attribute value of the point (such as a colour component value).

In the embodiment, the attribute information may include a colour component which may specifically be colour information in any colour space. For example, the attribute information may be colour information in the RGB space, colour information in the YUV space, or colour information in the YCbCr space, etc., which is not limited in the embodiment of the disclosure.

Further, in the embodiment of the disclosure, the colour component may include a first colour component, a second colour component, and a third colour component. In this way, if the colour component complies with the RGB colour space, then the first colour component may be determined as an R component, the second colour component may be determined as a G component, and the third colour component may be determined as a B component. If the colour component complies with the YUV colour space, then the first colour component may be determined as a Y component, the second colour component may be determined as a U component, and the third colour component may be determined as a V component. If the colour component complies with the YCbCr colour space, then the first colour component may be determined as a Y component, the second colour component may be determined as a Cb component, and the third colour component may be determined as a Cr component.

It may be understood that, in the embodiment of the disclosure, the attribute information of the point in the initial point cloud may be a colour component, reflectance, or other attributes, which is not limited in the embodiment of the disclosure.

It is noted that in the embodiment of the disclosure, the decoder may determine a residual value of the attribute information of the point in the initial point cloud by decoding the bitstream, so as to construct the reconstructed point cloud. Therefore, in some embodiments, the method can further include the following. The bitstream is decoded to determine the residual value of the attribute information of the point in the initial point cloud. After a predicted value of the attribute information of the point in the initial point cloud is determined, a reconstructed value of the attribute information of the point in the initial point cloud is determined according to the predicted value and the residual value of the attribute information of the point in the initial point cloud. The reconstructed point cloud is constructed based on the reconstructed value of the attribute information of the point in the initial point cloud.

That is to say, the predicted value and the residual value of the attribute information of the point in the initial point cloud may be determined first, and then a reconstructed value of the attribute information of the point is calculated with the predicted value and the residual value in order to construct the reconstructed point cloud. Specifically, during determination of the predicted value of the attribute information of the point in the initial point cloud, geometric information and attribute information of multiple target nearest points of the point may be used in combination with the geometric information of the point to predict the attribute information of the point, so as to obtain a corresponding predicted value and further determine a corresponding reconstructed value. In this way, after the reconstructed value of the attribute information of the point in the initial point cloud is determined, the point may be used as the nearest neighbour for subsequent points in the LODs, so that the reconstructed value of the attribute information of the point may be used for attribute prediction of subsequent points, and finally a reconstructed point cloud is obtained.

It is also noted that, in the embodiment of the disclosure, the initial point cloud may be obtained directly through a point cloud reading function in an encoding and decoding program, and the reconstructed point cloud is obtained after attribute encoding, attribute reconstruction, and geometric compensation. In addition, the reconstructed point cloud in the embodiment of the disclosure may be used as a reconstructed point cloud output after decoding, or may be used as a reference for decoding subsequent point clouds. In addition, the reconstructed point cloud may be used in a prediction loop, that is, used as an in-loop filter, and may be used as the reference for decoding the subsequent point clouds. Alternatively, the reconstructed point cloud may be used outside the prediction loop, that is, used as a post filter, and is not used as the reference for decoding the subsequent point clouds, which is not limited in the embodiment of the disclosure.

In addition, in the embodiment of the disclosure, the filtering identification information may include filtering identification information of a to-be-processed component of the attribute information. Specifically, in some embodiments, for S801, the bitstream is decoded to determine the filtering identification information as follows. The bitstream is decoded to determine the filtering identification information of the to-be-processed component, where the filtering identification information of the to-be-processed component indicates whether to filter the to-be-processed component of the attribute information of the reconstructed point cloud.

Further, in some embodiments, the bitstream is decoded to determine the filtering identification information specifically as follows. When a value of the filtering identification information of the to-be-processed component is a first value, it is determined to filter the to-be-processed component of the attribute information of the reconstruction point. When a value of the filtering identification information of the to-be-processed component is a second value, it is determined not to filter the to-be-processed component of the attribute information of the reconstructed point cloud.

It is also noted that when the to-be-processed component is the colour component, filtering identification information corresponding to each colour component may indicate whether to filter the colour component. Therefore, in some embodiments, the bitstream is decoded to determine the filtering identification information of the to-be-processed component as follows. The bitstream is decoded to determine filtering identification information of a first colour component, filtering identification information of a second colour component, and filtering identification information of a third colour component. The filtering identification information of the first colour component indicates whether to filter a first colour component of the attribute information of the reconstructed point cloud, the filtering identification information of the second colour component indicates whether to filter a second colour component of the attribute information of the reconstructed point cloud, and the filtering identification information of the third colour component indicates whether to filter a third colour component of the attribute information of the reconstructed point cloud.

That is to say, the filtering identification information may be in the form of an array which is specifically a 1×3 array and includes the filtering identification information of the first colour component, the filtering identification information of the second colour component, and the filtering identification information of the third colour component. For example, the filtering identification information may be represented as [y u v], where y represents the filtering identification information of the first colour component, u represents the filtering identification information of the second colour component, and v represents the filtering identification information of the third colour component.

It can be seen that since the filtering identification information includes the filtering identification information of each colour component, the filtering identification information may not only be used to determine whether to filter the reconstructed point cloud, but also be used to determine which one or more of the colour components should be filtered.

Further, in some embodiments, the bitstream is decoded to determine the filtering identification information specifically as follows. When a value of the filtering identification information of the first colour component is a first value, it is determined to filter the first colour component of the attribute information of the reconstructed point cloud, and when the value of the filtering identification information of the first colour component is a second value, it is determined not to filter the first colour component of the attribute information of the reconstructed point cloud. When a value of the filtering identification information of the second colour component is a first value, it is determined to filter the second colour component of the attribute information of the reconstructed point cloud, and when the value of the filtering identification information of the second colour component is a second value, it is determined not to filter the second colour component of the attribute information of the reconstructed point cloud. When a value of the filtering identification information of the third colour component is a first value, it is determined to filter the third colour component of the attribute information of the reconstructed point cloud, and when the value of the filtering identification information of the third colour component is a second value, it is determined not to filter the third colour component of the attribute information of the reconstructed point cloud.

That is to say, in the embodiment of the disclosure, if filtering identification information corresponding to a certain colour component is the first value, the filtering identification information indicates to filter the colour component. If filtering identification information corresponding to a certain colour component is the second value, the filtering identification information indicates not to filter the colour component.

Further, in some embodiments, the method may further include the following. When at least one of the filtering identification information of the first colour component, the filtering identification information of the second colour component, and the filtering identification information of the third colour component is a first value, it is determined that the filtering identification information indicates to filter the reconstructed point cloud. When each of the filtering identification information of the first colour component, the filtering identification information of the second colour component, and the filtering identification information of the third colour component is a second value, it is determined that the filtering identification information indicates not to filter the reconstructed point cloud.

That is to say, in the embodiment of the disclosure, if filtering identification information corresponding to each colour component is the second value, the filtering identification information indicates not to filter any of the colour components, that is, it may be determined that the filtering identification information indicates not to filter the reconstructed point cloud. Accordingly, if at least one of the filtering identification information of the colour components is the first value, the filtering identification information indicates to filter at least one colour component, that is, it may be determined that the filtering identification information indicates to filter the reconstructed point cloud.

In addition, in the embodiment of the disclosure, the first value is different from the second value, and the first value and the second value may be in parameter form or in numerical form. Specifically, the identification information corresponding to the colour components may be parameters written in a profile, or may be a value of a flag, which is not limited herein.

For example, for the first value and the second value, the first value may be set as 1, and the second value may be set as 0. Alternatively, the first value may be set as true, and the second value may be set as false, which is not limited herein.

At S802, when the filtering identification information indicates to filter the reconstructed point cloud, the bitstream is decoded to determine filtering coefficients. It is noted that in the embodiment of the disclosure, after the decoder decodes the bitstream and determines the filtering identification information, if the filtering identification information indicates to filter the reconstructed point cloud, the decoder may further determine the filtering coefficients for filtering.

It is also noted that the filter may be an adaptive filter, for example, the filter may be a neural-network-based filter, a Wiener filter, etc., which is not limited herein. Taking the Wiener filter as an example, the filtering coefficients described in the embodiments of the disclosure may be used for Wiener filtering, that is, the filtering coefficients are coefficients used for Wiener filtering processing.

Here, the Wiener filter is a linear filter with minimum mean square error as the optimal criterion. Under certain constraints, the square of the difference between an output of the Wiener filter and a given function (often called an expected output) is minimized, which may ultimately become a problem of solving a Toeplitz equation through mathematical operations. The Wiener filter is also called a least squares filter or a least mean squares filter.

It can be understood that in the embodiment of the disclosure, the filtering coefficients may be referred to as filtering coefficients corresponding to the to-be-processed component. Accordingly, when the filtering identification information indicates to filter the reconstructed point cloud, the bitstream is decoded to determine the filtering coefficients as follows. When the value of the filtering identification information of the to-be-processed component is the first value, the bitstream is decoded to determine the filtering coefficients corresponding to the to-be-processed component.

It is noted that when the to-be-processed component is the colour component, the colour component includes the first colour component, the second colour component, and the third colour component. Accordingly, the filtering coefficients may be filtering coefficients corresponding to the first colour component, filtering coefficients corresponding to the second colour component, and filtering coefficient vector corresponding to the third colour component. Specifically, in some embodiments, when the filtering identification information indicates to filter the reconstructed point cloud, the bitstream is decoded to determine the filtering coefficients as follows.

When the value of the filtering identification information of the first colour component is the first value, the bitstream is decoded to determine the filtering coefficients corresponding to the first colour component. When the value of the filtering identification information of the second colour component is the first value, the bitstream is decoded to determine the filtering coefficients corresponding to the second colour component. When the value of the filtering identification information of the third colour component is the first value, the bitstream is decoded to determine the filtering coefficients corresponding to the third colour component.

Further, in some embodiments, the method further includes the following. When the filtering identification information indicates not to filter the reconstructed point cloud, decoding of the bitstream to determine the filtering coefficients is skipped.

That is to say, in the embodiment of the disclosure, when the filtering identification information indicates to filter the reconstructed point cloud, the decoder may decode the bitstream to obtain the filtering coefficients directly. However, after the decoder decodes the bitstream and determines the filtering identification information, if the filtering identification information indicates not to filter a certain colour component of the reconstructed point cloud, the decoder does not need to decode to obtain the filtering coefficient vector corresponding to the colour component.

At S803, K target points corresponding to a first point in the reconstructed point cloud are filtered with the filtering coefficients to determine a filtered point cloud corresponding to the reconstructed point cloud.

It is noted that, the K target points include the first point and (K−1) nearest points adjacent to the first point, K is an integer greater than 1, and the first point represents any point in the reconstructed point cloud. The (K−1) nearest points here specifically refer to (K−1) nearest points that have smallest geometric distance to the first point.

It is also noted that in the embodiment of the disclosure, if the filtering identification information indicates to filter the reconstructed point cloud, then after filtering coefficients corresponding to the initial point cloud are determined, the reconstructed point cloud may further be filtered with the filtering coefficients, so that the filtered point cloud corresponding to the reconstructed point cloud may be obtained.

It is also noted that in the embodiment of the disclosure, in the case where the attribute information is the colour component, each colour component of the reconstructed point cloud may be filtered individually. For example, for colour information in the YUV space, filtering coefficients corresponding to the Y component, filtering coefficients corresponding to the U component, and filtering coefficients corresponding to the V component may be determined separately. These filtering coefficients together constitute the filtering coefficients of the reconstructed point cloud. In addition, since the filtering coefficients may be determined by a K-order filter, during filtering at the decoder end, KNN searching may be performed for each point in the reconstructed point cloud to determine K target points corresponding to each point, and filtering is performed with filtering coefficients of each point.

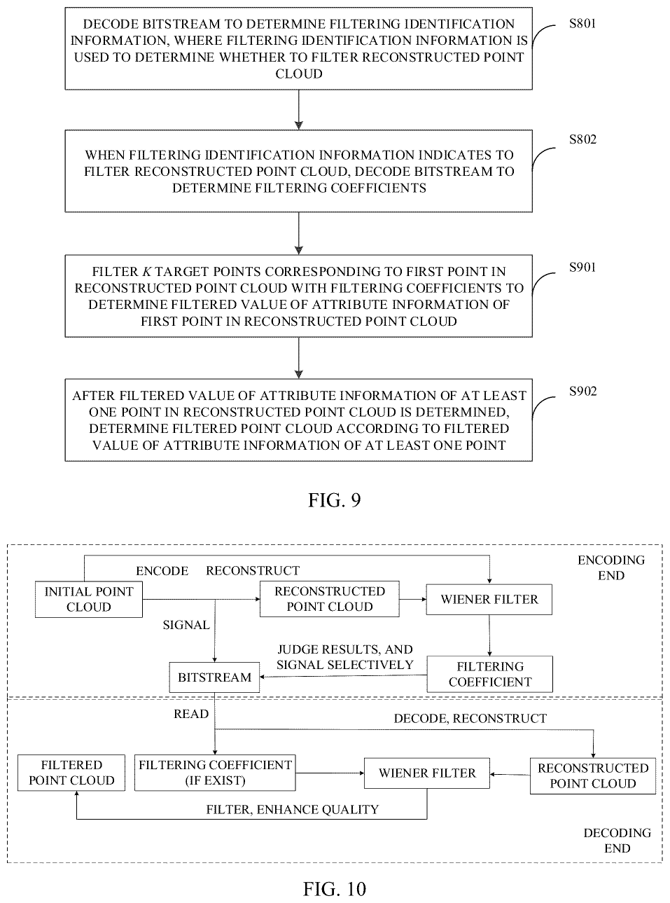

In some embodiments, reference is made to FIG. 9 which illustrates a schematic flowchart 2 of a decoding method provided in embodiments of the disclosure. As illustrated in FIG. 9, for S803, the operation can include the following.

At S901, the K target points corresponding to the first point in the reconstructed point cloud are filtered with the filtering coefficients to determine a filtered value of attribute information of the first point in the reconstructed point cloud.

At S902, after a filtered value of attribute information of at least one point in the reconstructed point cloud is determined, the filtered point cloud is determined according to the filtered value of the attribute information of the at least one point.

It is noted that in the embodiment of the disclosure, after determining the filtering coefficients, the decoder may further determine the filtered point cloud corresponding to the reconstructed point cloud with the filtering coefficients. Specifically, in some embodiments, the K target points corresponding to the first point in the reconstructed point cloud need to be first determined, where the first point represents any point in the reconstructed point cloud. Then, the K target points corresponding to the first point in the reconstructed point cloud are filtered with the filtering coefficients to determine the filtered point cloud corresponding to the reconstructed point cloud.

In a specific embodiment, the K target points corresponding to the first point in the reconstructed point cloud are determined as follows. A preset number of candidate points in the reconstructed point cloud are searched for based on the first point in the reconstructed point cloud by using the KNN neighbour search manner. A distance between the first point and each of the preset number of candidate points are calculated, and the (K−1) distances are selected from the preset number of distances obtained, where the (K−1) distances are all smaller than the remaining distances in the preset number of distances. (K−1) nearest points are determined according to the candidate points corresponding to the (K−1) distances, and the first point and the (K−1) nearest points are determined as the K target points corresponding to the first point.

It is noted that taking the first point as an example, the preset number of candidate points in the reconstructed point cloud may be searched for in the KNN search manner. The distances between the first point and each of the candidate points may be calculated, and then (K−1) nearest points closest to the first point may be selected from the candidate points. That is to say, not only the first point but also the (K−1) nearest points that have smallest geometric distance to the first point together form the K target points corresponding to the first point in the reconstructed point cloud.

It is also noted that, still taking the colour component in the attribute information as an example, the K target points corresponding to the first point in the reconstructed point cloud are filtered with the filtering coefficients as follows. The K target points corresponding to the first point in the reconstructed point cloud are filtered with the filtering coefficient vector corresponding to the colour component to obtain a filtered value of a colour component of the first point in the reconstructed point cloud. The filtered point cloud is obtained according to the filtered value of the colour component of the point in the reconstructed point cloud.

To put it simply, in the embodiment of the disclosure, during filtering the reconstructed point cloud with the filtering coefficients, according to the order of the Wiener filter and a reconstructed value of the attribute information of the K target points corresponding to the point in the reconstructed point cloud, a second attribute parameter corresponding to the attribute information may be determined first. Then the filtered value of the attribute information may be determined according to the filtering coefficients and the second attribute parameter. At last, the filtered point cloud may be obtained based on the filtered value of the attribute information.

It is noted that in the embodiment of the disclosure, if the attribute information is the colour component in the YUV space, the second attribute parameter (represented as P (n, k)) may be determined based on a reconstructed value of the colour component (for example, the Y component, the U component, or the V component) in combination with the order of the Wiener filter, that is, the second attribute parameter represents the reconstructed values of the colour component of the K target points corresponding to the point in the reconstructed point cloud.

It is also noted that for the Wiener filter, a filter type may indicate a filter order and/or a filter shape and/or a filter dimension. The filter shape includes a diamond, a rectangle, etc. The filter dimension may be one dimension, two dimensions, or higher dimensions.

That is to say, in the embodiment of the disclosure, different filter types may correspond to Wiener filters with different orders, for example, Wiener filters with orders of 12, 32, or 128. Different filter types may also correspond to filters with different dimensions, such as a one-dimensional filter, a two-dimensional filter, etc., which are not limited herein. In other words, if a 16-order filter needs to be determined, 16 points may be used to determine a 16-order asymmetric filter, an 8-order one-dimensional symmetric filter, or a filter of other numbers of dimensions (such as a two-dimensional filter, a three-dimensional filter, etc., which are more special). The filter is not limited herein.

It is noted that in the embodiment of the disclosure, the filtered value of a certain colour component may be determined with the second attribute parameter of the colour component and the filtering coefficient vector corresponding to the colour component. After all colour components are traversed and the filtered values of all colour components are obtained, the filtered point cloud may be obtained.

It can also be understood that in the embodiment of the disclosure, during filtering the reconstructed point cloud with the Wiener filter, the reconstructed point cloud and the filtering coefficient may be both inputted into the Wiener filter, that is, the input of the Wiener filter is the filtering coefficients and the reconstructed point cloud. At last, the reconstructed point cloud may be filtered based on the filtering coefficients to obtain the corresponding filtered point cloud.

That is to say, in the embodiment of the disclosure, the filtering coefficients are obtained based on the original point cloud and the reconstructed point cloud. Therefore, the original point cloud may be restored to the maximum extent by applying the filtering coefficients to the reconstructed point cloud. For example, in the embodiment of the disclosure, taking the colour component in the YUV space in the point cloud sequence as an example, the order of the filter is assumed as K, the point cloud sequence is assumed as n, and a matrix P (n, k) is used to represent reconstructed values of K target points corresponding to each point in the reconstructed point cloud in the same colour component (for example, the Y component), that is, P (n, k) is a second attribute parameter including reconstructed values of the Y component of the K target points corresponding to each point in the reconstructed point cloud.

In this way, based on the above equation (13), a filtered value R (n) of the attribute information of the Y component may be obtained by applying the filtering coefficient vector H (k) for the Y component to the reconstructed point cloud, i.e., the second attribute parameter P (n, k).

Then the U component and the V component may be traversed according to the method above. A filtered value in the U component and a filtered value in the V component may be determined at last. The filtered point cloud corresponding to the reconstructed point cloud may be determined with filtered values of all colour components.

In addition, in the embodiment of the disclosure, after determining the filtered point cloud corresponding to the reconstructed point cloud, the decoder may overwrite the reconstructed point cloud with the filtered point cloud.

It is noted that in the embodiment of the disclosure, compared with the reconstructed point cloud, the quality of the filtered point cloud obtained after filtering is significantly enhanced. Therefore, after the filtered point cloud is obtained, the original reconstructed point cloud may be overwritten by the filtered point cloud, so as to achieve quality enhancement in the entire encoding and decoding.

It is also noted that since point clouds are usually represented in RGB colour space, and point cloud visualization for the YUV components is difficult using existing applications, after the filtered point cloud corresponding to the reconstructed point cloud is determined, the method can further include the following. If the colour component of the point in the filtered cloud does not comply with the RGB colour space (for example, the YUV colour space, the YCbCr colour space, etc.), colour space conversion is performed on the filtered point cloud, so that the colour component of the point in the filtered cloud complies with the RGB colour space.

In this way, when the colour component of the point in the filtered point cloud complies with the YUV colour space, it is first necessary to convert the colour component of the filtered point cloud from the YUV colour space to the RGB colour space, and then the original reconstructed point cloud is updated with the filtered point cloud.

It can be understood that in the embodiment of the disclosure, if the filtering identification information indicates not to filter the reconstructed point cloud, the decoder may skip the filtering process and apply the reconstructed point cloud obtained according to an original procedure, that is, the decoder may not update the reconstructed point cloud.

Further, in the embodiment of the disclosure, as for determination of the order of the Wiener filter, the value of the order may be set equal to 16, so as to ensure the filtering effect and reduce time complexity to a certain extent.

In addition, if a neighbourhood difference value is considered in Wiener filtering at the encoding end, due to the large changes in attribute values at the point cloud contour or boundary, a single filter may be not suitable for filtering the entire point cloud, thus leaving room for improvement in effect, especially for sparse point cloud sequences. Therefore, classification may be performed according to the neighbourhood difference value. Different filters may be applied to different categories, for example, multiple Wiener filters with different orders may be set. In this case, the encoder passes multiple groups of filtering coefficients to the decoder. Accordingly, the decoder end will decode multiple groups of filtering coefficients to filter the reconstructed point cloud, so as to achieve an adaptive selection of filters for better filtering effects.

In short, the embodiment of the disclosure proposes an optimized technology for performing Wiener filtering on the YUV component of the coding colour reconstructed value to better improve the quality of the point cloud, specifically through the encoding method proposed in operations at S801 to S803. During filtering of the colour component (such as the Y component, the U component, and the V component) of the colour reconstructed value of the point cloud sequence, the Wiener filter-based post-processing method for point cloud in both the lossless geometry and lossy attribute case and the lossy geometry and lossy attribute case is considered. Further, the judgment for quality improvement, nearest point selection, and the value of K are optimized. In this way, quality improvement operation for the reconstructed point cloud that is output by the decoding end may be selectively performed, the number of bits of the bitstream can have a relatively small increase, and the overall compression performance can be improved.

It should be noted that the decoding method proposed in the embodiment of the disclosure is applicable for any point cloud sequence, and has a prominent optimization effect especially for a sequence with densely distributed points and a sequence with a medium bitrate. In addition, the decoding method proposed in the embodiment of the disclosure may be applied to all of three attribute transform (predicting transform, lifting transform, and RAHT) encoding manners, and has universality. For a very small number of sequences with poor filtering effects, the method will not affect the reconstruction at the decoding end. Except for a slight increase in the running time at the encoding end, the impact of the filtering identification information on the size of the attribute bitstream is negligible.

It is noted that the Wiener filter proposed in the embodiment of the disclosure may be used in a prediction loop, that is, used as an in-loop filter, and may be used as a reference for decoding subsequent point clouds. Alternatively, the Wiener filter may be used outside the prediction loop, that is, used as a post filter, and is not used as a reference for decoding subsequent point clouds, which is not limited herein.

It is noted that in the embodiment of the disclosure, if the Wiener filter proposed in the embodiment of the disclosure is the in-loop filter, when it is determined to perform filtering, parameter information (such as the filtering identification information) indicating to perform filtering needs to be signalled into the bitstream, and the filtering coefficients also need to be signalled into the bitstream. Accordingly, when it is determined not to perform filtering, the parameter information (such as the filtering identification information) indicating to perform filtering may not be signalled into the bitstream, and the filtering coefficients may also not be signalled into the bitstream. On the contrary, if the Wiener filter proposed in the embodiment of the disclosure is the post filter, in one case, the filtering coefficients corresponding to the filter are in a separate auxiliary information data unit (for example, supplementary enhancement information, SEI). In this case, the parameter information (such as the filtering identification information) indicating to perform filtering may not be signalled into the bitstream, and the filtering coefficients may also not be signalled into the bitstream. Accordingly, when the decoder does not obtain the SEI, the reconstructed point cloud will not be filtered. In another case, the filtering coefficients corresponding to the filter are in an auxiliary information data unit together with other information. In this case, when it is determined to perform filtering, the parameter information (such as the filtering identification information) indicating to perform filtering needs to be signalled into the bitstream, and the filtering coefficients also need to be signalled into the bitstream. Accordingly, when it is determined not to perform filtering, the parameter information (such as filtering identification information) indicating to perform filtering may not be signalled into the bitstream, and the filtering coefficients may also not be signalled into the bitstream.

Furthermore, for the decoding method proposed in the embodiment of the disclosure, filtering may be selectively performed on one or more parts of the reconstructed point cloud, that is, the control range of the filtering identification information may be the entire reconstructed point cloud or may be a certain part of the reconstructed point cloud, which is not limited herein.

The embodiment provides the decoding method which is applied to the decoder. The bitstream is decoded to determine the filtering coefficients, where the filtering coefficients are used to determine whether to filter the reconstructed point cloud. When the filtering identification information indicates to filter the reconstructed point cloud, the bitstream is decoded to determine the filtering coefficients. K target points corresponding to the first point in the reconstructed point cloud are filtered with the filtering coefficients to determine the filtered point cloud corresponding to the reconstructed point cloud, where the K target points include the first point and (K−1) nearest points adjacent to the first point, K is an integer greater than 1, and the first point represents any point in the reconstructed point cloud. In this way, at the decoding end, the filtering coefficients may be obtained directly by decoding and then used to filter the reconstructed point cloud with the filtering coefficients, thereby optimizing the reconstructed point cloud and improving the quality of the point cloud. In addition, at the encoding end, for filtering using nearest points, a current point is taken into account, so that a filtered value further depends on an attribute value of the current point. Moreover, not only a PSNR performance indicator but also a rate-distortion trade-off are considered for determining whether to filter the reconstructed point cloud. In addition, determination of correspondence between the reconstructed point cloud and the initial point cloud in a lossy geometry and lossy attribute case is also provided herein, so as to not only expand the scope of application and improve the quality of the point cloud, but also save bitrate and improve efficiency of encoding and decoding.

It can be understood that, a technical solution of quality enhancement based on Wiener filtering also exists in the related art, but this technical solution still has the following problems. Firstly, the current point is not taken into account in neighbourhood searching, so that the optimal value of the point under the minimum mean square error criterion is independent of the current value of the point and depends on only nearest points. This technical solution is obviously unreasonable. The quality of the point cloud processed according to this technical solution thus still has a lot of room for improvement. In addition, quality improvement is judged in a single way. It is one-sided to determine whether there is performance improvement only depending on the performance indicator PSNR. Since signalling a decision array and optimal coefficients into the bitstream requires increasing the total bitstream size, whether the compression ratio and overall performance are improved needs to be considered in combination with the quality improvement and bitstream size. Secondly, the applied filter order is relatively large (K=32), resulting in a long KNN searching time. An increase in PSNR is not necessarily directly proportional to the value of K, so that the computation complexity of the entire algorithm is relatively high, and the fast processing speed of G-PCC is hard to show. Thirdly, this technical solution can only be used for the lossless geometry and lossy attribute encoding manner, and cannot provide an effective processing manner for the lossy geometry and lossy attribute encoding manner. Therefore, the technical solution has poor universality, and the application range of Wiener filter-based post-processing is severely restricted.

Based on the encoding and decoding methods provided in the above embodiment, yet another embodiment of the disclosure proposes an optimized technology for performing Wiener filtering on the YUV component of the coding colour reconstructed value and decoding to better improve the quality of the point cloud. The Wiener filter-based post-processing method for point cloud in the lossy geometry and lossy attribute case is mainly provided. Further, the judgment for quality improvement, nearest point selection, and the value of K are optimized.

Taking filtering with a Wiener filter as an example, FIG. 10 is a schematic diagram of an overall process of encoding and decoding provided in embodiments of the disclosure. As illustrated in FIG. 10, at the encoding end, after an initial point cloud is encoded and reconstructed, a reconstructed point cloud can be obtained. The initial point cloud and the reconstructed point cloud may be used as an input of the Wiener filter. The output of the Wiener filter is filtering coefficients. Whether to filter the reconstructed point cloud will be determined according to effect judgment based on these filtering coefficients. Only when the reconstructed point cloud needs to be filtered, the corresponding filtering coefficients will be signalled into a bitstream. In addition, an attribute residual value obtained after the initial point cloud is encoded will also be signalled into the bitstream. In this way, at the decoding end, the decoder may obtain the attribute residual value by decoding the bitstream, and then obtain the reconstructed point cloud through decoding and reconstructing. In addition, if filtering coefficients exist in the bitstream, decoding is needed to obtain the corresponding filtering coefficients. The filtering coefficients and the reconstructed point cloud are input to the Wiener filter to output a filtered point cloud (i.e., an output point cloud), which has enhanced quality.

In a specific embodiment, FIG. 11 is a schematic flowchart of filtering at an encoding end provided in embodiments of the disclosure. As illustrated in FIG. 11, an initial point cloud and a reconstructed point cloud are used as inputs of the Wiener filter. The points in the initial point cloud and the points in the reconstructed point cloud are aligned in terms of position information, and conversion is performed on attribute information (for example, a colour component in the attribute information is converted from the RGB space to the YUV space). Calculation of the filtering coefficients may be performed with a colour component of the point in the initial point cloud and a colour component of the point in the reconstructed point cloud. An auto-correlation parameter may be calculated based on the colour component of the point in the reconstructed point cloud. A cross-correlation parameter may be calculated based on the colour component of the point in the initial point cloud and the colour component of the point in the reconstructed point cloud. At last, optimal filter coefficients, i.e., the corresponding filtering coefficients may be determined with the auto-correlation parameter and the cross-correlation parameter.

Specifically, at the encoding end, specific operations are as follows.

First, the input (i.e., the initial point cloud and the reconstructed point cloud) of the Wiener filter needs to be obtained. The initial point cloud may be obtained directly through a point cloud reading function in an encoding and decoding program, and the reconstructed point cloud is obtained after attribute encoding, attribute reconstruction, and geometric compensation. Wiener filtering may be performed after the reconstructed point cloud is obtained in the G-PCC.

It should be noted that in the lossless geometry and lossy attribute encoding manner, the number and coordinates of the points in the reconstructed point cloud do not change, so that matching with corresponding points in the initial point cloud is relatively easy, and correspondence between points may be obtained by using only the KNN search manner with k=1. However, for the lossy geometry and lossy attribute encoding manner, the number and coordinates of the points in the reconstructed point cloud obtained and the bounding box of the entire point cloud have big changes depending on different set bitrates. Therefore, a more accurate method for finding point-to-point correspondences is provided herein. In this method, geometric coordinates of the reconstructed point cloud are pre-processed first. After geometric compensation is performed, the geometric coordinate of each point is divided by a scale in the configuration parameter according to the reconstruction process. With the above operation, the reconstructed point cloud may be restored to a size equivalent to the original point cloud, and offsets of the coordinate may be eliminated. Subsequently, the KNN search manner with k=5 is used in the initial point cloud for each point in the reconstructed point cloud. Distances between each of the 5 points and the current point are calculated in sequence, and the nearest point with the minimum distance is stored. If there are multiple nearest points with the same minimum distance, the nearest points with the same distance to the current point may be merged into one point, that is, an average value of attribute values of the nearest points is taken as a true attribute value of a matching nearest point of the current point. In this way, a point cloud that has the same number of points as the reconstructed point cloud can be obtained, where points in the point cloud are in one-to-one correspondence with the point in the reconstructed point cloud. The point cloud is input as a real initial point cloud into the Wiener filter.

Secondly, the function of the Wiener filter at the encoding end is mainly to calculate the filtering coefficients and determine whether the quality of the point cloud is improved after Wiener filtering. After the initial point cloud and the reconstructed point cloud are input, optimal coefficients (i.e., filtering coefficients) of the Wiener filter may be calculated by applying the principle of the Wiener filter algorithm. Since the order of the filter (the number of target points selected in filtering, i.e., K) and the number of attribute information that needs to be filtered will affect the quality of the filtered point cloud, after multiple experiments, K=16 is selected for balancing performance and efficiency. Note that the K target points include the current point and (K−1) nearest points adjacent to the point. The encoding end will also filter all three YUV components (to obtain the filtering performance on these three components). Under this condition, after the filtering coefficients are obtained, the filtered point cloud may be obtained (in this case, there is no need to overwrite the reconstructed point cloud).

Further, for both the filtered point cloud and the reconstructed point cloud, PSNR values in YUV components are calculated respectively. Also, in order to more accurately measure whether the performance is improved after filtering, in the solution, rate-distortion trade-off is considered on both the filtered point cloud and the reconstructed point cloud. A cost value considering both quality improvement and increased bitstream may be calculated with a rate-distortion cost function, to represent compression efficiency of a point cloud that is not subject to filtering and compression efficiency of a point cloud that is subject to filtering. The specific calculation of the cost value (represented by J) is as the above equation (14).

In this way, after PSNR and J corresponding to each colour component are calculated for the reconstructed point cloud and the filtered point cloud, if for the filtered point cloud, the PSNR in one or several components increases while J decreases compared with the reconstructed point cloud, for example, if the PSNR value in the V component increases and J decreases, then only the V component will be filtered at the decoding end. In this case, a decision array of size 1×3 (i.e., the filtering identification information in the aforementioned embodiments, used to determine whether it is needed to perform post-processing, that is, filtering, and which component(s) is to be filtered at the decoding end, for example, [0,1,1] indicating to filter the U component and the V component) is first signalled into the bitstream, and then the filtering coefficients are signalled into the bitstream. If no PSNR increases or all J increases, it means that the performance is declined after filtering. In this case, the decision array and the filtering coefficients will not be signalled into the bitstream, so as to avoid reducing the encoding and decoding efficiency. Wiener filtering also will not be performed at the decoding end.

Furthermore, in order to determine the optimal value of K, in the embodiment of the disclosure, the BD-Rate gains and running times before and after filtering are tested for a test sequence using lifting transform under the CTC_C1 (lossless geometry and lossy attribute) condition and r1-r6 bitrates. The specific results are illustrated in FIG. 6 and FIG. 7. It may be seen that infinitely increasing K is not beneficial to performance improvement. When processing a large point cloud, excessive K is prone to memory overflow, and thus reduces universality. Therefore, K is set to 16 here to ensure the filtering effect while reducing the time complexity to a certain extent.

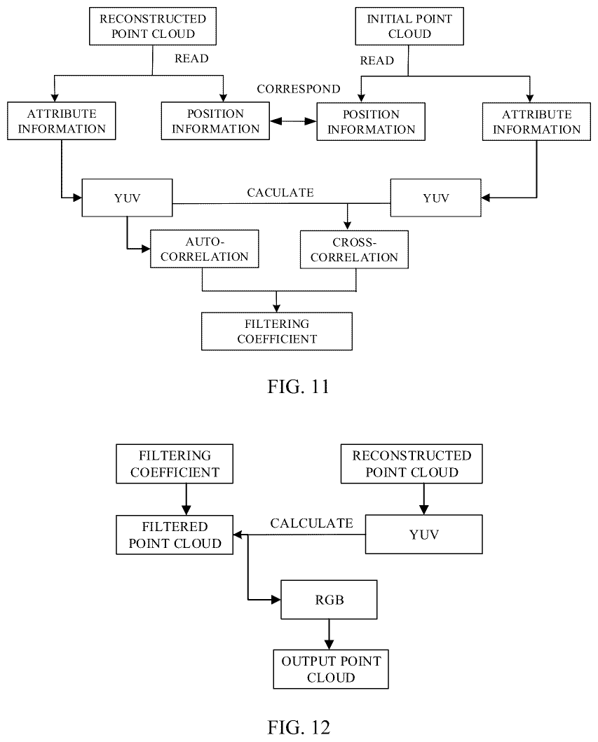

In another specific embodiment, FIG. 12 is a schematic flowchart of filtering at a decoding end provided in embodiments of the disclosure. As illustrated in FIG. 12, when a decoder performs Wiener filtering, a reconstructed point cloud and filtering coefficients may be used as inputs of a Wiener filter at the decoding end. After attribute information of a point in the reconstructed point cloud is converted (for example, a colour component in the attribute information is converted from the RGB space to the YUV space), filtering may be performed with the filtering coefficients. Through calculation, a quality-enhanced filtered point cloud may be obtained. After the conversion (from the YUV space to the RGB space) of the attribute information of a point in the filtered point cloud is completed, the filtered point cloud is output.

Specifically, at the decoding end, the specific operations are as follows.

Firstly, after the attribute residual value is decoded in the G-PCC, the decoding may be continued. First, a 1×3 decision array is decoded. If it is determined that certain component(s) needs to be filtered, then it means filtering coefficients are passed from the encoding end, and Wiener filtering can improve the quality of the reconstructed point cloud. Otherwise, decoding will not be continued, and the Wiener filtering will be skipped. The point cloud reconstruction will be performed according to an original procedure to obtain the reconstructed point cloud.

Secondly, after the filtering coefficients are decoded, the filtering coefficients may be passed to a stage where the point cloud is reconstructed. In this case, the reconstructed point cloud and the filtering coefficients may be input to the Wiener filter at the decoder end. The quality-enhanced filtered point cloud may be obtained through calculation. The quality-enhanced filtered point cloud replaces the reconstructed point cloud to complete the entire encoding and decoding and achieve quality enhancement.

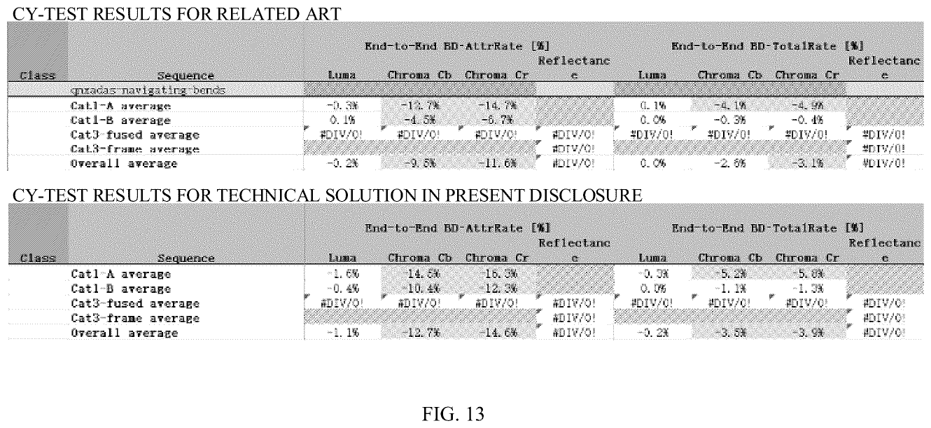

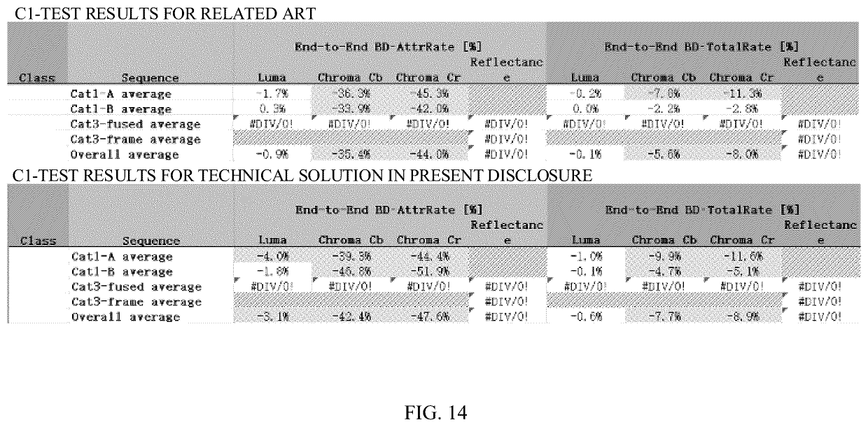

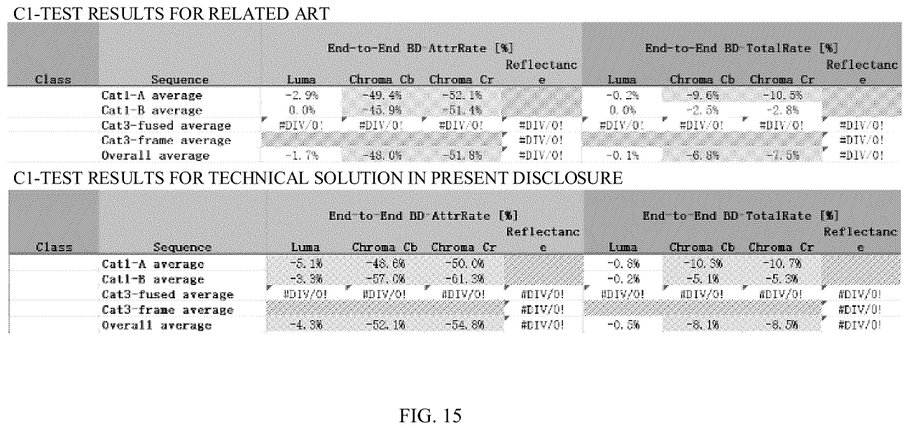

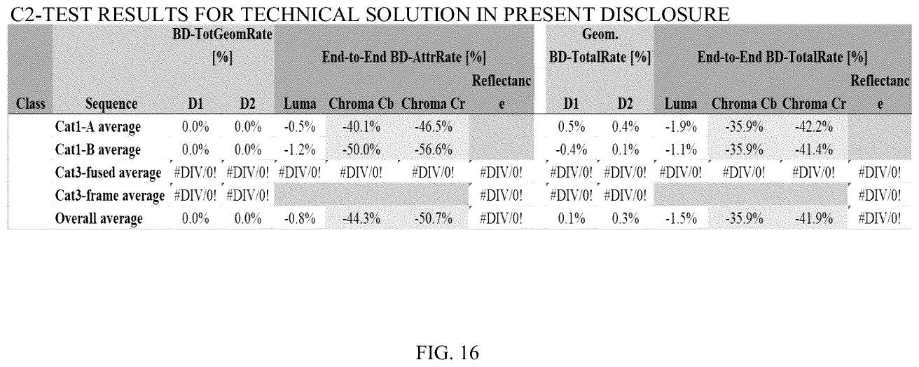

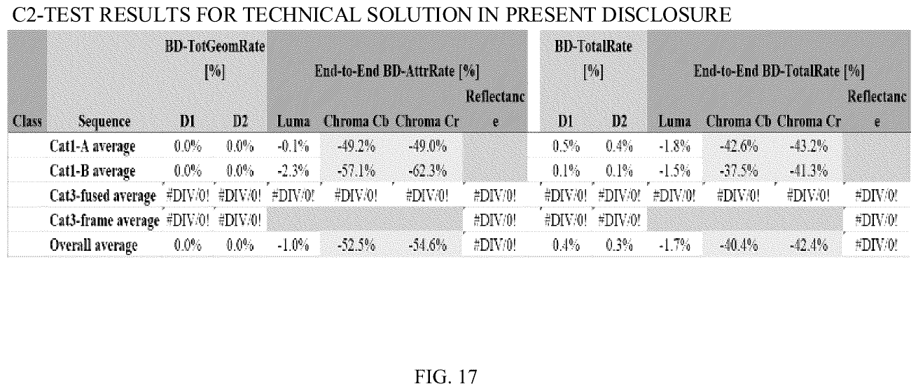

Further, in the embodiment of the disclosure, FIG. 13 is a schematic diagram illustrating a comparison of test results of predicting transform under the CY test condition in the related art and the technical solution provided in the embodiments of the disclosure, and FIG. 14 is a schematic diagram illustrating a comparison of test results of lifting transform under the C1 test condition in the related art and the technical solution provided in the embodiments of the disclosure. FIG. 15 is a schematic diagram illustrating a comparison of test results RAHT under the C1 test condition in the related art and the technical solution provided in the embodiments of the disclosure. FIG. 16 is a schematic diagram illustrating test results of lifting transform under the C2 test condition provided in the embodiments of the disclosure. FIG. 17 is a schematic diagram illustrating test results of RAHT under the C2 test condition provided in the embodiments of the disclosure. As illustrated in FIG. 13 to FIG. 17, after the encoding and decoding methods proposed in the embodiments of the disclosure are implemented on the G-PCC reference software TMC13 V12.0, part of the test sequences required by MPEG are tested (cat1-A&cat1-B) under the CTC CY, C1, and C2 test conditions, and the final test results of the lossless attribute encoding manner are also compared with test results of the related art.

The CY condition is the lossless geometry and lossy attribute encoding manner. The C1 condition is the lossless geometry and near-lossless attribute encoding manner. The C2 condition is the lossy geometry and lossy attribute encoding manner. In the above test results, End-to-End BD-AttrRate represents the BD-Rate of an end-to-end attribute value for an attribute bitstream. BD-Rate reflects the difference in PSNR curves under two cases (with or without filtering). When BD-Rate decreases, it means that the bitrate decreases and performance improves under equal PSNR; otherwise, performance decreases. That is, the more the BD-Rate decreases, the better the compression effect. Cat1-A average and Cat1-B average respectively represent the average value of test effects of the point cloud sequence of two data sets. The Overall average is the average value of test effects of all sequences.

It may be seen that the encoding and decoding methods proposed in the embodiment of the disclosure are mainly optimized technologies for quality enhancement using attribute Wiener filtering at the decoding end for a G-PCC point cloud, which may selectively perform quality enhancement on a reconstructed point cloud output by the decoding end, and has a prominent optimization effect especially for a sequence with densely distributed points and a sequence with a medium bitrate sequence. Moreover, there is no obvious increase in the number of bitstream bits, so that the compression performance is improved. The technology may be applied to all of three attribute transform (predicting transform, lifting transform, and RAHT) encoding manners, and has universality. For a very small number of sequences with poor filtering effects, the technology will not affect the reconstruction process at the decoding end. Except for a slight increase in the running time at the encoding end, the impact of the filtering identification information on the size of the attribute bitstream is negligible.

Compared with the related art, firstly, during filtering with nearest points, the current point is introduced into the calculation, that is, the filtered value of the point also depends on its own attribute value. Through testing, it is found that a coefficient corresponding to the current point is larger among the optimal coefficients, which means that the attribute value of the point has a larger weight in filtering. Therefore, it is necessary to take the current point into consideration for calculation. It can be seen from the test results that the final BD-Rate is greatly improved, which also proves that the operation is effective. Secondly, before information such as filtering coefficients is signalled into the bitstream, the method for determining whether the overall performance is improved after filtering is optimized. Considering that the ultimate purpose of G-PCC is point cloud compression, the higher the compression rate, the better the overall performance. Compared with the related art that determines whether to perform filtering at the decoding end only based on the PSNR value, the embodiment of the disclosure proposes to calculate the costs before and after filtering of each channel (Y, U, V) with a cost function to perform rate-distortion trade-offs. Not only improvement of the quality of an attribute value is considered in the method, but also the cost of signalling information such as filtering coefficients into the bitstream is calculated in the method. The improvement and the cost are considered together to determine whether the compression performance is improved after filtering, thereby determining whether to pass filtering coefficients and perform operations at the decoding end. Moreover, the value of the filter order K is improved. In order to ensure the filtering effect while reducing the running time and increasing universality, a systematic test is conducted and K=16 is selected for filtering in the embodiment of the disclosure. Further, the embodiment of the disclosure can filter the reconstructed point cloud obtained in the GPCC lossy geometry and lossy attribute encoding manner, and proposes a method for one-to-one correspondence between the points in a geometry-distorted reconstructed point cloud and the points in the original point cloud, thereby further improving the scope of application.

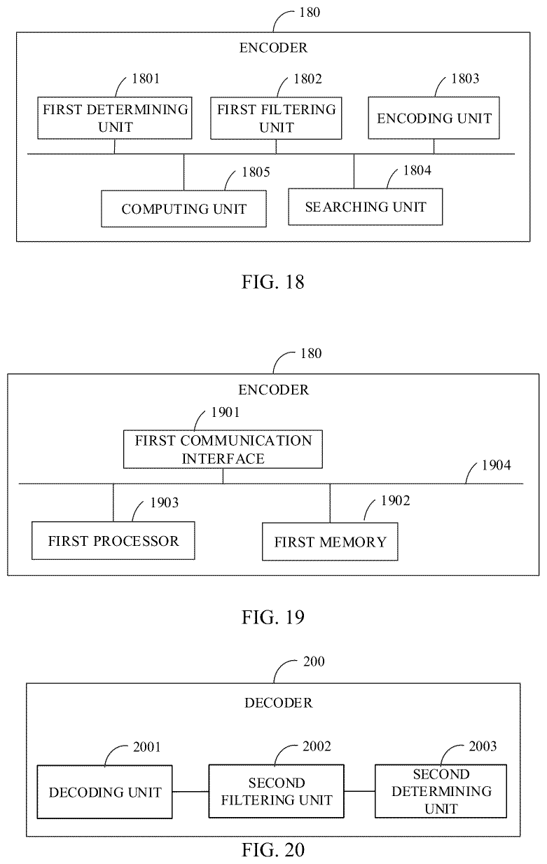

In yet another embodiment of the disclosure, based on the same inventive concept of the previous embodiments, reference is made to FIG. 18 which is a schematic structural diagram of an encoder 180 provided in embodiments of the disclosure. As illustrated in FIG. 18, the encoder 180 may include a first determining unit 1801, a first filtering unit 1802, and an encoding unit 1803.

The first determining unit 1801 is configured to determine an initial point cloud and a reconstructed point cloud and determine filtering coefficients according to the initial point cloud and the reconstructed point cloud.

The first filtering unit 1802 is configured to filter K target points corresponding to a first point in the reconstructed point cloud with the filtering coefficients to determine a filtered point cloud corresponding to the reconstructed point cloud, where the K target points include the first point and (K−1) nearest points adjacent to the first point, K is an integer greater than 1, and the first point represents any point in the reconstructed point cloud.

The first determining unit 1801 is further configured to determine filtering identification information according to the reconstructed point cloud and the filtered point cloud, where the filtering identification information is used to determine whether to filter the reconstructed point cloud.

The encoding unit 1803 is configured to encode the filtering identification information and the filtering coefficients and signal obtained encoding bits into a bitstream when the filtering identification information indicates to filter the reconstructed point cloud.

In some embodiments, the first determining unit 1801 is also configured to, when a first-type encoding manner is used to encode and reconstruct the initial point cloud, obtain a first reconstructed point cloud and determine the first reconstructed point cloud as the reconstructed point cloud, where the first-type encoding manner is used to perform lossless geometry and lossy attribute encoding on the initial point cloud.

In some embodiments, the first determining unit 1801 is further configured to, obtain a second reconstructed point cloud when a second-type encoding manner is used to encode and reconstruct the initial point cloud, and perform geometric restoration on the second reconstructed point cloud to obtain a restored reconstructed point cloud and determine the restored reconstructed point cloud as the reconstructed point cloud, where the second-type encoding manner is used to perform lossy geometry and lossy attribute encoding on the initial point cloud.

In some embodiments, the first determining unit 1801 is further configured to perform geometric compensation on the second reconstructed point cloud to obtain an intermediate reconstructed point cloud, and scale the intermediate reconstructed point cloud to obtain the restored reconstructed point cloud, where the restored reconstructed point cloud has a same size and a same geometric position as the initial point cloud.

In some embodiments, referring to FIG. 18, the encoder 180 may further include a searching unit 1804 which is configured to determine, for a point in the reconstructed point cloud, a corresponding point in the initial point cloud according to a first preset search manner when the first-type encoding manner is used, and establish correspondence between points in the reconstructed point cloud and points in the initial point cloud.

In some embodiments, the searching unit 1804 is further configured to determine, for a point in the reconstructed point cloud, a corresponding point in the initial point cloud according to a second preset search manner when the second-type encoding manner is used, construct a matching point cloud according to the corresponding point determined and establish, taking the matching point cloud as the initial point cloud, correspondence between points in the reconstructed point cloud and points in the initial point cloud.

In some embodiments, a first preset search manner is a K-nearest neighbour search manner for searching for a first constant number of points, and a second preset search manner is a K-nearest neighbour search manner for searching for a second constant number of points.

In some embodiments, the searching unit 1804 is specifically configured to search for a second constant number of points in the initial point cloud based on a current point in the reconstructed point cloud by using the second preset search manner, calculate distances between the current point and each of the second constant number of points and select a minimum distance from the distances, determine a point corresponding to the minimum distance as a corresponding point of the current point when the number of minimum distances is 1, and determine a corresponding point of the current point according to multiple points corresponding to the minimum distances when the number of minimum distances is multiple.

In some embodiments, the first constant is equal to 1 and the second constant is equal to 5.

In some embodiments, the first determining unit 1801 is further configured to determine the K target points corresponding to the first point in the reconstructed point cloud.

Accordingly, the first filtering unit 1802 is specifically configured to filter, with the filtering coefficients, the K target points corresponding to the first point in the reconstructed point cloud to determine a filtered value of attribute information of the first point in the reconstructed point cloud, and determine the filtered point cloud according to the filtered value of the attribute information of the at least one point after a filtered value of attribute information of at least one point in the reconstructed point cloud is determined.

In some embodiments, the first determining unit 1801 is further configured to search for a preset number of candidate points in the reconstructed point cloud based on the first point in the reconstructed point cloud by using a K-nearest neighbour search manner, calculate a distance between the first point and each of the preset number of candidate points and select (K−1) distances from a preset number of distances obtained, where the (K−1) distances are all smaller than remaining distances in the preset number of distances, and determine (K−1) nearest points according to candidate points corresponding to the (K−1) distances and determine the first point and the (K−1) nearest points as the K target points corresponding to the first point.

In some embodiments, the first determining unit 1801 is further configured to determine a first attribute parameter according to an original value of attribute information of a point in the initial point cloud, determine a second attribute parameter according to reconstructed values of attribute information of K target points corresponding to a point in the reconstructed point cloud, and determine the filtering coefficients based on the first attribute parameter and the second attribute parameter.

In some embodiments, the first determining unit 1801 is further configured to determine a cross-correlation parameter according to the first attribute parameter and the second attribute parameter, determine an auto-correlation parameter according to the second attribute parameter, and perform coefficient calculation according to the cross-correlation parameter and the auto-correlation parameter to obtain the filtering coefficients.

In some embodiments, the attribute information includes a colour component, and the colour component includes at least one of: a first colour component, a second colour component, and a third colour component, where when the colour component complies with an RGB colour space, the first colour component is determined as an R component, the second colour component is determined as a G component, and the third colour component is determined as a B component, and when the colour component complies with a YUV colour space, the first colour component is determined as a Y component, the second colour component is determined as a U component, and the third colour component is determined as a V component.

In some embodiments, referring to FIG. 18, the encoder 180 may further include a computing unit 1805 configured to determine a first cost value of a to-be-processed component of attribute information of the reconstructed point cloud and determine a second cost value of a to-be-processed component of attribute information of the filtered point cloud.

The first determining unit 1801 is further configured to determine filtering identification information of the to-be-processed component according to the first cost value and the second cost value, and obtain the filtering identification information according to the filtering identification information of the to-be-processed component.

In some embodiments, the first determining unit 1801 is further configured to, when the second cost value is smaller than the first cost value, determine that a value of the filtering identification information of the to-be-processed component is a first value, and when the second cost value is greater than the first cost value, determine that the value of the filtering identification information of the to-be-processed component is a second value. In some embodiments, the computing unit 1805 is specifically configured to perform cost-value calculation on the to-be-processed component of the attribute information of the reconstructed point cloud by using a rate-distortion cost manner and determine an obtained first rate-distortion value as the first cost value, and perform cost-value calculation on the to-be-processed component of the attribute information of the filtered point cloud by using the rate-distortion cost manner and determine an obtained second rate-distortion value as the second cost value.

In some embodiments, the computing unit 1805 is further configured to perform cost-value calculation on the to-be-processed component of the attribute information of the reconstructed point cloud by using a rate-distortion cost manner to obtain a first rate-distortion value, and perform, with a preset performance measurement indicator, performance-value calculation on the to-be-processed component of the attribute information of the reconstructed point cloud to obtain a first performance value.

The first determining unit 1801 is further configured to determine the first cost value according to the first rate-distortion value and the first performance value.

In some embodiments, the computing unit 1805 is further configured to perform cost-value calculation on the to-be-processed component of the attribute information of the filtered point cloud by using the rate-distortion cost manner to obtain a second rate-distortion value, and perform, with a preset performance measurement indicator, performance-value calculation on the to-be-processed component of the attribute information of the filtered point cloud to obtain a second performance value.

The first determining unit 1801 is further configured to determine the second cost value according to the second rate-distortion value and the second performance value.

In some embodiments, the first determining unit 1801 is further configured to, when the second performance value is greater than the first performance value and the second rate-distortion value is smaller than the first rate-distortion value, determine that a value of the filtering identification information of the to-be-processed component is a first value, and when the second performance value is smaller than the first performance value, determine that the value of the filtering identification information of the to-be-processed component is a second value.

In some embodiments, the first determining unit 1801 is further configured to when the second performance value is greater than the first performance value and the second rate-distortion value is smaller than the first rate-distortion value, determine that a value of the filtering identification information of the to-be-processed component is a first value, and when the second rate-distortion value is greater than the first rate-distortion value, determine that the value of the filtering identification information of the to-be-processed component is a second value.

In some embodiments, the first determining unit 1801 is further configured to, when the value of the filtering identification information of the to-be-processed component is the first value, determine that the filtering identification information of the to-be-processed component indicates to filter the to-be-processed component of the attribute information of the reconstructed point cloud, and when the value of the filtering identification information of the to-be-processed component is the second value, determine that the filtering identification information of the to-be-processed component indicates not to filter the to-be-processed component of the attribute information of the reconstructed point cloud.

In some embodiments, the first determining unit 1801 is further configured to, when the to-be-processed component is a colour component, determine filtering identification information of a first colour component, filtering identification information of a second colour component, and filtering identification information of a third colour component, and obtain the filtering identification information according to the filtering identification information of the first colour component, the filtering identification information of the second colour component, and the filtering identification information of the third colour component.

In some embodiments, the first determining unit 1801 is further configured to, when at least one of the filtering identification information of the first colour component, the filtering identification information of the second colour component, and the filtering identification information of the third colour component is a first value, determine that the filtering identification information indicates to filter the reconstructed point cloud, and when each of the filtering identification information of the first colour component, the filtering identification information of the second colour component, and the filtering identification information of the third colour component is a second value, determine that the filtering identification information indicates not to filter the reconstructed point cloud.

In some embodiments, the encoding unit 1803 is further configured to, when the filtering identification information indicates not to filter the reconstructed point cloud, encode only the filtering identification information and signal obtained encoding bits into the bitstream.

In some embodiments, the first determining unit 1801 is further configured to determine a value of K according to a point number of the reconstructed point cloud, and/or determine the value of K according to a quantization parameter of the reconstructed point cloud, and/or determine the value of K according to a neighbourhood difference value of a point in the reconstructed point cloud, where the neighbourhood difference value is obtained based on a component difference value between attribute information of the point and attribute information of at least one nearest point.

In some embodiments, the first determining unit 1801 is further configured to, when the neighbourhood difference value of the point in the reconstructed point cloud is in a first preset interval, select a first-type filter to filter the reconstructed point cloud, and when the neighbourhood difference value of the point in the reconstructed point cloud is in a second preset interval, select a second-type filter to filter the reconstructed point cloud, where an order of the first-type filter is different from an order of the second-type filter.

In some embodiments, the first determining unit 1801 is further configured to determine a predicted value of attribute information of a point in the initial point cloud, and determine a residual value of the attribute information of the point in the initial point cloud according to an original value and the predicted value of the attribute information of the point in the initial point cloud.

The encoding unit 1803 is further configured to encode the residual value of the attribute information of the point in the initial point cloud and signal obtained encoding bits into the bitstream.

It can be understood that in the embodiments of the disclosure, the “unit” may be part of a circuit, part of a processor, part of a program or software, etc., and of course may also be a module, or may be non-modular. In addition, various components described in embodiments of the disclosure may be integrated into one processing unit or may be present as a number of physically separated units, and two or more units may be integrated into one. The integrated unit may take the form of hardware or a software functional unit.

If the integrated units are implemented as software functional units and sold or used as standalone products, they may be stored in a computer-readable storage medium. Based on such an understanding, the essential technical solution, or the portion that contributes to the prior art, or all or part of the technical solution of the disclosure may be embodied as software products. The computer software products may be stored in a storage medium and may include multiple instructions that, when executed, may cause a computing device, e.g., a personal computer, a server, a network device, etc., or a processor to execute some or all operations of the methods described in various embodiments. The above storage medium may include various kinds of media that may store program codes, such as a universal serial bus (USB) flash disk, a mobile hard drive, a ROM, a RAM, a magnetic disk, or an optical disk.

Therefore, a computer storage medium applied to the encoder 180 is provided in embodiments of the disclosure. The computer storage medium stores a computer program. The computer program, when executed by a first processor, is configured to implement the method of any one of the foregoing embodiments.

Based on the components of the encoder 180 and the computer storage medium, reference is made to FIG. 19 which is a schematic diagram of a specific hardware structure of the encoder 180 provided in embodiments of the disclosure. As illustrated in FIG. 19, the encoder 180 may include a first communication interface 1901, a first memory 1902, and a first processor 1903. Various components are coupled together via a first bus system 1904. It can be understood that, the first bus system 1904 is configured for connection and communication between these components. In addition to a data bus, the first bus system 1904 further includes a power bus, a control bus, and a status signal bus. However, for the convenience of illustration, various buses are marked as the first bus system 1904 in FIG. 19.

The first communication interface 1901 is configured to receive and send signals in the process of sending and receiving information with other external network elements. The first memory 1902 stores a computer program executed by the first processor 1903. The first processor 1903 is configured to, when executing the computer program, determine the initial point cloud and the reconstructed point cloud, determine the filtering coefficients according to the initial point cloud and the reconstructed point cloud, filter, with the filtering coefficients, K target points corresponding to the first point in the reconstructed point cloud to determine the filtered point cloud corresponding to the reconstructed point cloud, where the K target points include the first point and (K−1) nearest points adjacent to the first point, K is an integer greater than 1, and the first point represents any point in the reconstructed point cloud, determine the filtering identification information according to the reconstructed point cloud and the filtered point cloud, where the filtering identification information is used to determine whether to filter the reconstructed point cloud, and when the filtering identification information indicates to filter the reconstructed point cloud, encode the filtering identification information and the filtering coefficients and signal the obtained encoding bits into the bitstream.

It can be understood that, the first memory 1902 in embodiments of the disclosure may be a volatile memory or a non-volatile memory, or may include both the volatile memory and the non-volatile memory. The non-volatile memory may be a ROM, a PROM, an erasable PROM (EPROM), an electric EPROM (EEPROM), or flash memory. The volatile memory can be a random access memory (RAM) that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It is noted that, the first memory 1902 of the systems and methods described in the disclosure is intended to include, but is not limited to, these and any other suitable types of memory.

The first processor 1903 may be an integrated circuit chip with signal processing capabilities. In the embodiments, each step of the foregoing method may be completed by an integrated logic circuit in the form of hardware or an instruction in the form of software in the first processor 1903. The first processor 1903 may be a general-purpose processor, a digital signal processor (DSP), an application specific integrated circuit (ASIC), a field programmable gate array (FPGA), or other programmable logic devices, discrete gates or transistor logic devices, discrete hardware components, etc. The first processor 1903 may implement or execute the methods, operations, and logic blocks disclosed in embodiments of the disclosure. The general purpose processor may be a microprocessor, or may be any conventional processor or the like. The operations of the method disclosed in embodiments of the disclosure may be implemented through a hardware decoding processor, or may be performed by hardware and software modules in the decoding processor. The software module may be located in a storage medium. The storage medium is located in the first memory 1902. The first processor 1903 reads the information in the first memory 1902, and completes the operations of the method described above with the hardware of the first processor 1903.

It will be appreciated that embodiments described herein may be implemented in one or more of hardware, software, firmware, middleware, and microcode. For hardware embodiment, the processing unit may be implemented in one or more ASICs, DSPs, DSP devices (DSPD), programmable logic devices (PLD), FPGAs, general purpose processors, controllers, microcontrollers, microprocessors, other electronic units for performing the functions described herein or a combination thereof. For a software embodiment, the technology described herein may be implemented by modules (e.g., procedures, functions, and so on) for performing the functions described herein. The software code may be stored in the memory and executed by the processor. The memory may be implemented in the processor or external to the processor.

Optionally, as another embodiment, the first processor 1903 is further configured to, when executing the computer program, perform the method of any one of the foregoing embodiments.

The embodiment provides the encoder which may include the first determining unit, the first filtering unit, and an encoding unit. In this way, at the encoding end, the initial point cloud and the reconstructed point cloud are used to calculate the filtering coefficients for filtering, and the corresponding filtering coefficients are passed to the decoder after the reconstructed point cloud is determined to be filtered. Accordingly, at the decoding end, the filtering coefficients may be obtained directly by decoding and then used to filter the reconstructed point cloud with the filtering coefficients, thereby optimizing the reconstructed point cloud and improving the quality of the point cloud. In addition, at the encoding end, for filtering using nearest points, the current point is also taken into account, so that the filtered value further depends on the attribute value of the current point. Moreover, not only the PSNR performance indicator but also the rate-distortion for trade-off are considered for determining whether to filter the reconstructed point cloud. Furthermore, determination of correspondence between the reconstructed point cloud and the initial point cloud in the lossy geometry and lossy attribute case is also provided herein, so as to not only expand the scope of application and improve the quality of the point cloud, but also save bitrate and improve efficiency of encoding and decoding.

Based on the same inventive concept of the previous embodiment, reference is made to FIG. 20 which is a schematic structural diagram of a decoder 200 provided in embodiments of the disclosure. As illustrated in FIG. 20, the decoder 200 can include a decoding unit 2001 and a second filtering unit 2002.

The decoding unit 2001 is configured to decode a bitstream to determine filtering identification information, where the filtering identification information is used to determine whether to filter a reconstructed point cloud, and when the filtering identification information indicates to filter the reconstructed point cloud, decode the bitstream to determine filtering coefficients.

The second filtering unit 2002 is configured to filter, with the filtering coefficients, K target points corresponding to a first point in the reconstructed point cloud to determine a filtered point cloud corresponding to the reconstructed point cloud, where the K target points comprise the first point and (K−1) nearest points adjacent to the first point, K is an integer greater than 1, and the first point represents any point in the reconstructed point cloud.

In some embodiments, referring to FIG. 20, the decoder 200 can further include a second determining unit 2003 configured to determine the K target points corresponding to the first point in the reconstructed point cloud.

Accordingly, the second filtering unit 2002 is specifically configured to filter, with the filtering coefficients, the K target points corresponding to the first point in the reconstructed point cloud to determine a filtered value of attribute information of the first point in the reconstructed point cloud, and after a filtered value of attribute information of at least one point in the reconstructed point cloud is determined, determine the filtered point cloud according to the filtered value of the attribute information of the at least one point.

In some embodiments, the second determining unit 2003 is specifically configured to search for a preset number of candidate points in the reconstructed point cloud based on the first point in the reconstructed point cloud by using a K-nearest neighbour search manner, calculate a distance between the first point and each of the preset number of candidate points and select (K−1) distances from a preset number of distances obtained, where the (K−1) distances are all smaller than remaining distances in the preset number of distances, and determine (K−1) nearest points according to candidate points corresponding to the (K−1) distances and determine the first point and the (K−1) nearest points as the K target points corresponding to the first point.

In some embodiments, the decoding unit 2001 is further configured to decode the bitstream to determine a residual value of attribute information of a point in the initial point cloud.

The second determining unit 2003 is further configured to, after a predicted value of the attribute information of the point in the initial point cloud is determined, determine a reconstructed value of the attribute information of the point in the initial point cloud according to the predicted value and the residual value of the attribute information of the point in the initial point cloud, and construct the reconstructed point cloud based on the reconstructed value of the attribute information of the point in the initial point cloud.

In some embodiments, the attribute information includes a colour component, and the colour component includes at least one of: a first colour component, a second colour component, and a third colour component, where when the colour component complies with an RGB colour space, the first colour component is determined as an R component, the second colour component is determined as a G component, and the third colour component is determined as a B component, and when the colour component complies with a YUV colour space, the first colour component is determined as a Y component, the second colour component is determined as a U component, and the third colour component is determined as a V component.

In some embodiments, the decoding unit 2001 is further configured to decode the bitstream to determine filtering identification information of a to-be-processed component, where the filtering identification information of the to-be-processed component indicates whether to filter a to-be-processed component of attribute information of the reconstructed point cloud.

In some embodiments, the second determining unit 2003 is further configured to, when a value of the filtering identification information of the to-be-processed component is a first value, determine to filter the to-be-processed component of the attribute information of the reconstructed point cloud, and when the value of the filtering identification information of the to-be-processed component is a second value, determine not to filter the to-be-processed component of the attribute information of the reconstructed point cloud.

Accordingly, the second filtering unit 2002 is further configured to, when the value of the filtering identification information of the to-be-processed component is the first value, decode the bitstream to determine filtering coefficients corresponding to the to-be-processed component.

In some embodiments, the decoding unit 2001 is further configured to decode the bitstream to determine filtering identification information of a first colour component, filtering identification information of a second colour component, and filtering identification information of a third colour component, where the filtering identification information of the first colour component indicates whether to filter a first colour component of the attribute information of the reconstructed point cloud, the filtering identification information of the second colour component indicates whether to filter a second colour component of the attribute information of the reconstructed point cloud, and the filtering identification information of the third colour component indicates whether to filter a third colour component of the attribute information of the reconstructed point cloud.

In some embodiments, the second determining unit 2003 is further configured to, when a value of the filtering identification information of the first colour component is a first value, determine to filter the first colour component of the attribute information of the reconstructed point cloud, and when the value of the filtering identification information of the first colour component is a second value, determine not to filter the first colour component of the attribute information of the reconstructed point cloud.

Accordingly, the second filtering unit 2002 is further configured to, when the value of the filtering identification information of the first colour component is the first value, decode the bitstream to determine filtering coefficients corresponding to the first colour component.

In some embodiments, the second determining unit 2003 is further configured to, when a value of the filtering identification information of the second colour component is a first value, determine to filter the second colour component of the attribute information of the reconstructed point cloud, and when the value of the filtering identification information of the second colour component is a second value, determine not to filter the second colour component of the attribute information of the reconstructed point cloud.

Accordingly, the second filtering unit 2002 is further configured to, when the value of the filtering identification information of the second colour component is the first value, decode the bitstream to determine filtering coefficients corresponding to the second colour component.

In some embodiments, the second determining unit 2003 is further configured to, when a value of the filtering identification information of the third colour component is a first value, determine to filter the third colour component of the attribute information of the reconstructed point cloud, and when the value of the filtering identification information of the third colour component is a second value, determine not to filter the third colour component of the attribute information of the reconstructed point cloud.

Accordingly, the second filtering unit 2002 is further configured to, when the value of the filtering identification information of the third colour component is the first value, decode the bitstream to determine filtering coefficients corresponding to the third colour component.

In some embodiments, the second determining unit 2003 is further configured to, when at least one of the filtering identification information of the first colour component, the filtering identification information of the second colour component, and the filtering identification information of the third colour component is a first value, determine that the filtering identification information indicates to filter the reconstructed point cloud, and when each of the filtering identification information of the first colour component, the filtering identification information of the second colour component, and the filtering identification information of the third colour component is a second value, determine that the filtering identification information indicates not to filter the reconstructed point cloud.

In some embodiments, the second filtering unit 2002 is further configured to, when the filtering identification information indicates not to filter the reconstructed point cloud, skip decoding the bitstream to determine the filtering coefficients.

In some embodiments, the second filtering unit 2002 is further configured to, when a colour component of a point in the filtered point cloud does not comply with an RGB colour space, perform colour space conversion on the filtered point cloud to enable the colour component of the point in the filtered point cloud to comply with the RGB colour space.

It can be understood that in the embodiments of the disclosure, the “unit” may be part of a circuit, part of a processor, part of a program or software, etc., and of course may also be a module, or may be non-modular. In addition, various components described in embodiments of the disclosure may be integrated into one processing unit or may be present as a number of physically separated units, and two or more units may be integrated into one. The integrated unit may take the form of hardware or a software functional unit.

If the integrated units are implemented as software functional units and sold or used as standalone products, they may be stored in a computer-readable storage medium. Based on such an understanding, the embodiment provides the computer storage medium applied in the decoder 200. The computer storage medium stores the computer program. The computer program, when executed by the second processor, implements the method of any one of the foregoing embodiments.

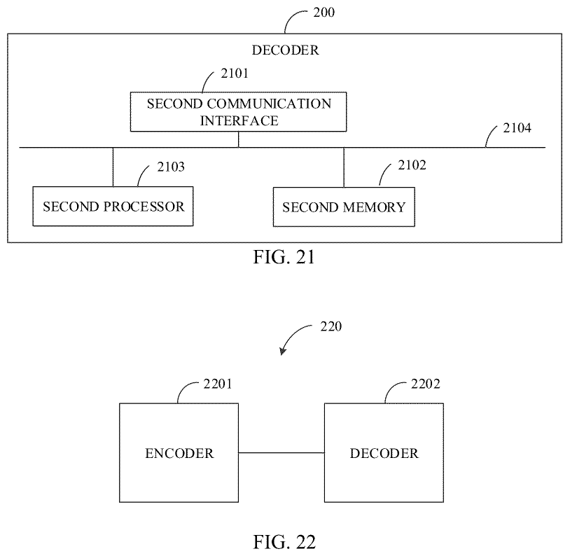

Based on the components of the decoder 200 and the computer storage medium, reference is made to FIG. 21 which is a schematic diagram of a specific hardware structure of the decoder 200 provided in embodiments of the disclosure. As illustrated in FIG. 21, the decoder 200 can include a second communication interface 2101, a second memory 2102, and a second processor 2103. Various components are coupled together via a second bus system 2104. It can be understood that, the second bus system 2104 is configured for connection and communication between these components. In addition to a data bus, the second bus system 2104 further includes a power bus, a control bus, and a status signal bus. However, for the convenience of illustration, various buses are marked as the second bus system 2104 in FIG. 21.

The second communication interface 2101 is configured to receive and send signals in the process of sending and receiving information with other external network elements. The second memory 2102 stores a computer program executed by the second processor 2103. The second processor 2103 is configured to decode a bitstream to determine filtering identification information, where the filtering identification information is used to determine whether to filter a reconstructed point cloud, decode the bitstream to determine filtering coefficients when the filtering identification information indicates to filter the reconstructed point cloud, and filter, with the filtering coefficients, K target points corresponding to a first point in the reconstructed point cloud to determine a filtered point cloud corresponding to the reconstructed point cloud, where the K target points include the first point and (K−1) nearest points adjacent to the first point, K is an integer greater than 1, and the first point represents any point in the reconstructed point cloud.

Optionally, as another embodiment, the second processor 2103 is further configured to perform the method of any one of the foregoing embodiments when executing the computer program.

It is understood that, in terms of hardware function, the second memory 2102 is similar to the first memory 1902, and the second processor 2103 is similar to the first processor 1903, which will not be repeated herein.

The embodiment provides the decoder which can include the decoding unit and the second filtering unit. In this way, at the decoding end, the filtering coefficients may be obtained directly by decoding and then used to filter the reconstructed point cloud with the filtering coefficients, thereby optimizing the reconstructed point cloud and improving the quality of the point cloud. In addition, at the encoding end, for filtering using nearest points, the current point is also taken into account, so that the filtered value further depends on the attribute value of the current point. Moreover, not only the PSNR performance indicator but also the rate-distortion trade-off are considered for determining whether to filter the reconstructed point cloud. Furthermore, determination of correspondence between the reconstructed point cloud and the initial point cloud in the lossy geometry and lossy attribute case is also provided herein, so as to not only expand the scope of application and improve the quality of the point cloud, but also save bitrate and improve efficiency of encoding and decoding.

In yet another embodiment of the disclosure, reference is made to FIG. 22 which is a schematic structural diagram of an encoding and decoding system provided in embodiments of the disclosure. As illustrated in FIG. 22, a coding system 220 can include an encoder 2201 and a decoder 2202. The encoder 2201 may be an encoder described in any one of the foregoing embodiments, and the decoder 2202 may be a decoder described in any one of the foregoing embodiments.

In the coding system 220 provided in the embodiments of the disclosure, at the encoding end, the initial point cloud and the reconstructed point cloud are used to calculate the filtering coefficients for filtering, and the corresponding filtering coefficients are passed to the decoder after the reconstructed point cloud is determined to be filtered. Accordingly, at the decoding end, the filtering coefficients may be obtained directly by decoding and then used to filter the reconstructed point cloud with the filtering coefficients, thereby optimizing the reconstructed point cloud and improving the quality of the point cloud. In addition, at the encoding end, for filtering using nearest points, the current point is also taken into account, so that the filtered value further depends on the attribute value of the current point. Moreover, not only the PSNR performance indicator but also the rate-distortion trade-off are considered for determining whether to filter the reconstructed point cloud. Furthermore, determination of correspondence between the reconstructed point cloud and the initial point cloud in the lossy geometry and lossy attribute case is also provided herein, so as to not only expand the scope of application and improve the quality of the point cloud, but also save bitrate and improve efficiency of encoding and decoding.

It is noted that in the disclosure, the terms “include”, “comprise”, or any other variations thereof are intended to cover non-exclusive inclusion, such that a process, method, article, or device that includes a series of elements not only includes those elements but also includes other elements not expressly listed or elements inherent in such process, method, article, or apparatus. Without further limitation, an element defined by the statement “comprises a . . . ” does not exclude the presence of additional identical elements in a process, method, article, or device that includes the element.

The sequence numbers in the embodiments of the disclosure are only for description and do not represent the advantages or disadvantages of the embodiments.

The methods disclosed in several method embodiments provided in the disclosure may be combined in any manner without conflicts to obtain a new method embodiment.

The methods disclosed in several product embodiments provided in the disclosure may be combined in any manner without conflict to obtain a new product embodiment.

The features disclosed in the several method embodiments provided in the disclosure may be combined in any manner without conflicts to obtain a new method embodiment or a new device embodiment.

The foregoing elaborations are merely embodiments of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

In the embodiments of the disclosure, in the encoder, the initial point cloud and the reconstructed point cloud are determined. The filtering coefficients are determined according to the initial point cloud and the reconstructed point cloud. K target points corresponding to the first point in the reconstructed point cloud are filtered with the filtering coefficients to determine the filtered point cloud corresponding to the reconstructed point cloud, where the K target points include the first point and (K−1) nearest points adjacent to the first point, K is an integer greater than 1, and the first point represents any point in the reconstructed point cloud. The filtering identification information is determined based on the reconstructed point cloud and the filtered point cloud, where the filtering identification information is used to determine whether to filter the reconstructed point cloud. When the filtering identification information indicates to filter the reconstructed point cloud, the filtering identification information and the filtering coefficients are encoded, and obtained encoding bits are signalled into the bitstream. In the decoder, the bitstream is decoded to determine the filtering identification information, where the filtering identification information is used to determine whether to filter the reconstructed point cloud. When the filtering identification information indicates to filter the reconstructed point cloud, the bitstream is decoded to determine the filtering coefficients. K target points corresponding to the first point in the reconstructed point cloud are filtered with the filtering coefficients to determine the filtered point cloud corresponding to the reconstructed point cloud, where the K target points include the first point and the (K−1) nearest points adjacent to the first point, K is an integer greater than 1, and the first point represents any point in the reconstructed point cloud. In this way, at the encoding end, the initial point cloud and the reconstructed point cloud are used to calculate the filtering coefficients for filtering, and the corresponding filtering coefficients are passed to the decoder after the reconstructed point cloud is determined to be filtered. Accordingly, at the decoding end, the filtering coefficients may be obtained directly by decoding and then used to filter the reconstructed point cloud with the filtering coefficients, thereby optimizing the reconstructed point cloud and improving the quality of the point cloud. In addition, at the encoding end, for filtering using nearest points, the current point is also taken into account, so that a filtered value further depends on an attribute value of the current point. Moreover, not only considers a PSNR performance indicator but also a rate-distortion trade-off are considered for determining whether to filter the reconstructed point cloud. Furthermore, determination of correspondence between the reconstructed point cloud and the initial point cloud in a lossy geometry and lossy attribute case is also provided herein, so as to not only expand the scope of application and improve the quality of the point cloud, but also save bitrate and improve efficiency of encoding and decoding.

What is claimed is:

1. A decoding method, applied to a decoder and comprising:
decoding a bitstream to determine filtering identification information, wherein the filtering identification information is used to determine whether to filter a reconstructed point cloud;
when the filtering identification information indicates to filter the reconstructed point cloud, decoding the bitstream to determine filtering coefficients; and
filtering, with the filtering coefficients, K target points corresponding to a first point in the reconstructed point cloud to determine a filtered point cloud corresponding to the reconstructed point cloud, wherein the K target points comprise the first point and (K−1) nearest points adjacent to the first point, K is an integer greater than 1, and the first point represents any point in the reconstructed point cloud.

2. The method of claim 1, wherein the method further comprises:
determining the K target points corresponding to the first point in the reconstructed point cloud; and
accordingly, filtering, with the filtering coefficients, the K target points corresponding to the first point in the reconstructed point cloud to determine the filtered point cloud corresponding to the reconstructed point cloud comprises:
filtering, with the filtering coefficients, the K target points corresponding to the first point in the reconstructed point cloud to determine a filtered value of attribute information of the first point in the reconstructed point cloud; and
after determining a filtered value of attribute information of at least one point in the reconstructed point cloud, determining the filtered point cloud according to the filtered value of the attribute information of the at least one point.

3. The method of claim 2, wherein determining the K target points corresponding to the first point in the reconstructed point cloud comprises:
searching for a preset number of candidate points in the reconstructed point cloud based on the first point in the reconstructed point cloud by using a K-nearest neighbour search manner;
calculating a distance between the first point and each of the preset number of candidate points and selecting (K−1) distances from a preset number of distances obtained, wherein the (K−1) distances are all smaller than remaining distances in the preset number of distances; and
determining (K−1) nearest points according to candidate points corresponding to the (K−1) distances and determining the first point and the (K−1) nearest points as the K target points corresponding to the first point.

4. The method of claim 1, further comprising:
decoding the bitstream to determine a residual value of attribute information of a point in an initial point cloud;
after determining a predicted value of the attribute information of the point in the initial point cloud, determining a reconstructed value of the attribute information of the point in the initial point cloud according to the predicted value and the residual value of the attribute information of the point in the initial point cloud; and
constructing the reconstructed point cloud based on the reconstructed value of the attribute information of the point in the initial point cloud.

5. The method of claim 1, wherein decoding the bitstream to determine the filtering identification information comprises:
decoding the bitstream to determine filtering identification information of a to-be-processed component,
wherein the filtering identification information of the to-be-processed component indicates whether to filter a to-be-processed component of attribute information of the reconstructed point cloud.

6. The method of claim 5, wherein decoding the bitstream to determine the filtering identification information of the to-be-processed component comprises:
when a value of the filtering identification information of the to-be-processed component is a first value, determining to filter the to-be-processed component of the attribute information of the reconstructed point cloud; and
when the value of the filtering identification information of the to-be-processed component is a second value, determining not to filter the to-be-processed component of the attribute information of the reconstructed point cloud; and
accordingly, when the filtering identification information indicates to filter the reconstructed point cloud, decoding the bitstream to determine the filtering coefficients comprises:
when the value of the filtering identification information of the to-be-processed component is the first value, decoding the bitstream to determine filtering coefficients corresponding to the to-be-processed component.

7. The method of claim 5, wherein when the to-be-processed component is a colour component, decoding the bitstream to determine the filtering identification information of the to-be-processed component comprises
decoding the bitstream to determine filtering identification information of a first colour component, filtering identification information of a second colour component, and filtering identification information of a third colour component,
wherein the filtering identification information of the first colour component indicates whether to filter a first colour component of the attribute information of the reconstructed point cloud, the filtering identification information of the second colour component indicates whether to filter a second colour component of the attribute information of the reconstructed point cloud, and the filtering identification information of the third colour component indicates whether to filter a third colour component of the attribute information of the reconstructed point cloud.

8. The method of claim 7, further comprising:
when at least one of the filtering identification information of the first colour component, the filtering identification information of the second colour component, or the filtering identification information of the third colour component is a first value, determining that the filtering identification information indicates to filter the reconstructed point cloud; and
when each of the filtering identification information of the first colour component, the filtering identification information of the second colour component, and the filtering identification information of the third colour component is a second value, determining that the filtering identification information indicates not to filter the reconstructed point cloud.

9. The method of claim 8, further comprising:
when the filtering identification information indicates not to filter the reconstructed point cloud, skipping decoding the bitstream to determine the filtering coefficients.

10. An encoding method, applied to an encoder and comprising:
determining an initial point cloud and a reconstructed point cloud;
determining filtering coefficients according to the initial point cloud and the reconstructed point cloud;
filtering, with the filtering coefficients, K target points corresponding to a first point in the reconstructed point cloud to determine a filtered point cloud corresponding to the reconstructed point cloud, wherein the K target points comprise the first point and (K−1) nearest points adjacent to the first point, K is an integer greater than 1, and the first point represents any point in the reconstructed point cloud;
determining filtering identification information according to the reconstructed point cloud and the filtered point cloud, wherein the filtering identification information is used to determine whether to filter the reconstructed point cloud; and
when the filtering identification information indicates to filter the reconstructed point cloud, encoding the filtering identification information and the filtering coefficients and signalling obtained encoding bits into a bitstream.

11. The method of claim 10, wherein determining the initial point cloud and the reconstructed point cloud comprises:
when a first-type encoding manner is used to encode and reconstruct the initial point cloud, obtaining a first reconstructed point cloud and determining the first reconstructed point cloud as the reconstructed point cloud,
wherein the first-type encoding manner is used to perform lossless geometry and lossy attribute encoding on the initial point cloud;
or,
when a second-type encoding manner is used to encode and reconstruct the initial point cloud, obtaining a second reconstructed point cloud; and
performing geometric restoration on the second reconstructed point cloud to obtain a restored reconstructed point cloud, and determining the restored reconstructed point cloud as the reconstructed point cloud,
wherein the second-type encoding manner is used to perform lossy geometry and lossy attribute encoding on the initial point cloud.

12. The method of claim 11, further comprising:
when the first-type encoding manner is used, determining, for a point in the reconstructed point cloud, a corresponding point in the initial point cloud according to a first preset search manner, and establishing correspondence between points in the reconstructed point cloud and points in the initial point cloud;
or,
when the second-type encoding manner is used, determining, for a point in the reconstructed point cloud, a corresponding point in the initial point cloud according to a second preset search manner; and
constructing a matching point cloud according to the corresponding point determined, and by taking the matching point cloud as the initial point cloud, establishing correspondence between points in the reconstructed point cloud and points in the initial point cloud.

13. The method of claim 10, wherein the method further comprises:
determining the K target points corresponding to the first point in the reconstructed point cloud; and
accordingly, filtering, with the filtering coefficients, the K target points corresponding to the first point in the reconstructed point cloud to determine the filtered point cloud corresponding to the reconstructed point cloud comprises:
filtering, with the filtering coefficients, the K target points corresponding to the first point in the reconstructed point cloud to determine a filtered value of attribute information of the first point in the reconstructed point cloud; and
after determining a filtered value of attribute information of at least one point in the reconstructed point cloud, determining the filtered point cloud according to the filtered value of the attribute information of the at least one point.

14. The method of claim 13, wherein determining the K target points corresponding to the first point in the reconstructed point cloud comprises:
searching for a preset number of candidate points in the reconstructed point cloud based on the first point in the reconstructed point cloud by using a K-nearest neighbour search manner;
calculating a distance between the first point and each of the preset number of candidate points and selecting (K−1) distances from a preset number of distances obtained, wherein the (K−1) distances are all smaller than remaining distances in the preset number of distances; and
determining (K−1) nearest points according to candidate points corresponding to the (K−1) distances and determining the first point and the (K−1) nearest points as the K target points corresponding to the first point.

15. The method of claim 10, wherein determining the filtering coefficients according to the initial point cloud and the reconstructed point cloud comprises:
determining a first attribute parameter according to an original value of attribute information of a point in the initial point cloud;
determining a second attribute parameter according to reconstructed values of attribute information of K target points corresponding to a point in the reconstructed point cloud; and
determining the filtering coefficients based on the first attribute parameter and the second attribute parameter.

16. The method of claim 1, wherein determining the filtering identification information according to the reconstructed point cloud and the filtered point cloud comprises:
determining a first cost value of a to-be-processed component of attribute information of the reconstructed point cloud and determining a second cost value of a to-be-processed component of attribute information of the filtered point cloud;
determining filtering identification information of the to-be-processed component according to the first cost value and the second cost value; and
obtaining the filtering identification information according to the filtering identification information of the to-be-processed component; and
wherein the method further comprises:
when the value of the filtering identification information of the to-be-processed component is the first value, determining that the filtering identification information of the to-be-processed component indicates to filter the to-be-processed component of the attribute information of the reconstructed point cloud; and
when the value of the filtering identification information of the to-be-processed component is the second value, determining that the filtering identification information of the to-be-processed component indicates not to filter the to-be-processed component of the attribute information of the reconstructed point cloud.

17. The method of claim 16, wherein obtaining the filtering identification information according to the filtering identification information of the to-be-processed component comprises:
when the to-be-processed component is a colour component, determining filtering identification information of a first colour component, filtering identification information of a second colour component, and filtering identification information of a third colour component; and
obtaining the filtering identification information according to the filtering identification information of the first colour component, the filtering identification information of the second colour component, and the filtering identification information of the third colour component.

18. The method of claim 10, further comprising:
determining a value of K according to a point number of the reconstructed point cloud; and/or
determining the value of K according to a quantization parameter of the reconstructed point cloud; and/or
determining the value of K according to a neighbourhood difference value of a point in the reconstructed point cloud, wherein the neighbourhood difference value is obtained based on a component difference value between attribute information of the point and attribute information of at least one nearest point.

19. The method of claim 18, wherein determining the value of K according to the neighbourhood difference value of the point in the reconstructed point cloud further comprises:
when the neighbourhood difference value of the point in the reconstructed point cloud is in a first preset interval, selecting a first-type filter to filter the reconstructed point cloud; and
when the neighbourhood difference value of the point in the reconstructed point cloud is in a second preset interval, selecting a second-type filter to filter the reconstructed point cloud,
wherein an order of the first-type filter is different from an order of the second-type filter.

20. A non-transitory computer storage medium storing a bitstream generated according to an encoding method, wherein the encoding method comprises:
determining an initial point cloud and a reconstructed point cloud;
determining filtering coefficients according to the initial point cloud and the reconstructed point cloud;
filtering, with the filtering coefficients, K target points corresponding to a first point in the reconstructed point cloud to determine a filtered point cloud corresponding to the reconstructed point cloud, wherein the K target points comprise the first point and (K−1) nearest points adjacent to the first point, K is an integer greater than 1, and the first point represents any point in the reconstructed point cloud;
determining filtering identification information according to the reconstructed point cloud and the filtered point cloud, wherein the filtering identification information is used to determine whether to filter the reconstructed point cloud; and
when the filtering identification information indicates to filter the reconstructed point cloud, encoding the filtering identification information and the filtering coefficients and signalling obtained encoding bits into a bitstream.
